(19) United States
(12) Patent Application Publication
(10) Pub. No.: US 2018/0310198 A1
(43) Pub. Date: Oct. 25, 2018

(54) WAKEUP RADIO MODE CONTROL FIELD AND WAKEUP FRAME BEHAVIOR

(71) Applicant: QUALCOMM Incorporated, San Diego, CA (US)

(72) Inventors: Yan Zhou, San Diego, CA (US); George Cherian, San Diego, CA (US)

(21) Appl. No.: 15/957,189

(22) Filed: Apr. 19, 2018

Related U.S. Application Data
(60) Provisional application No. 62/487,615, filed on Apr. 20, 2017.

(51) Int. Cl. H04W 28/02; H04W 52/02

(52) U.S. Cl. CPC H04W 28/0221; H04W 28/0236; H04W 52/0216; H04W 52/0235

(57) ABSTRACT

Methods, systems, and devices for wireless communication are described. A high throughput (HT) control field of a media access control (MAC) header may be configured as a wakeup radio (WUR) mode high efficiency (HE) control field such that WUR operation related information may be piggybacked over data. Therefore, any transmission frames that include a MAC header (e.g., data frames, management frames, etc.) may convey WUR operation information. The WUR operation information may include station (STA) WUR wakeup schedules, access point (AP) WUR beacon schedules, AP acknowledgment timeout intervals, STA primary radio power up time, etc. Further, a number of successive wakeup packet transmissions and/or WUR acknowledgement timeout interval durations may be determined (e.g., by an AP) as a function of quality of service (QoS) requirements associated with pending or buffered traffic for a STA.

### CROSS REFERENCES

The present application for patent claims benefit of U.S. Provisional Patent Application No. 62/487,615 by Zhou et al., entitled “Wakeup Radio Mode Control Field and Wakeup Frame Behavior,” filed Apr. 20, 2017, assigned to the assignee hereof, and expressly incorporated by reference in its entirety.

### BACKGROUND

The following relates generally to wireless communication, and more specifically to wakeup radio (WUR) mode high efficiency (HE) control field design and wakeup frame transmission techniques.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

A wireless device may have a limited amount of battery power. In some cases, it may be beneficial for a primary radio (e.g., of a wireless device) to remain in a sleep mode or low power mode for extended periods of time. During a sleep mode, a wireless device may periodically activate a radio, such as a wakeup radio (which may also be referred to as a WUR or wakeup receiver), to listen for and decode a wakeup signal (e.g., wakeup transmissions or wakeup frames) from an AP. The wireless device may then power on a primary radio of the wireless device in response to receiving the wakeup signal from an AP. Configuration of WUR operation related information may result in unnecessary overhead. Improved techniques for exchanging WUR operation related information may thus be desired.

### SUMMARY

The described techniques relate to improved methods, systems, devices, or apparatuses that support wakeup radio (WUR) mode high efficiency (HE) control field design and wakeup frame transmission techniques. An access point (AP) and a station (STA) may establish a wireless communication link, where the STA includes a main radio and a WUR. An AP or STA may populate a control field (e.g., configure a WUR mode HE control field) with WUR operation information. The WUR operation information may include STA WUR wakeup schedules, AP WUR beacon schedules, AP acknowledgment timeout intervals, STA primary radio power up time, etc. The AP and/or STA may then transmit the control field in a media access control (MAC) header of a frame over the wireless communication link to convey the WUR operation information.

Further an AP may transmit a wakeup packet to a STA and await an acknowledgement timeout interval for reception of an acknowledgement (ACK) of the wakeup packet from the STA. The acknowledgement timeout interval may be determined as a function of pending traffic between the AP and the STA (e.g., as a function of quality of service (QoS) requirements associated with the pending traffic). Further, an AP may determine a number of wakeup packets to transmit to a STA (e.g., a number of successive wakeup packet transmissions), where the number of wakeup packets is determined as a function of pending traffic between the AP and the STA (e.g., as a function of QoS requirements associated with the pending traffic). The AP may then transmit the wakeup packets to the STA until an acknowledgement is received from the STA or until the determined number of wakeup packets are transmitted.

A method of wireless communication is described. The method may include establishing a wireless communication link between a station and an access point, the station including a main radio and a wake-up radio, populating a control field with wake-up radio operation information, and transmitting the control field in a MAC header of a frame over the wireless communication link.

An apparatus for wireless communication is described. The apparatus may include means for establishing a wireless communication link between a station and an access point, the station including a main radio and a wake-up radio, means for populating a control field with wake-up radio operation information, and means for transmitting the control field in a MAC header of a frame over the wireless communication link.

Another apparatus for wireless communication is described. The apparatus may include a processor, memory in electronic communication with the processor, and instructions stored in the memory. The instructions may be operable to cause the processor to establish a wireless communication link between a station and an access point, the station including a main radio and a wake-up radio, populate a control field with wake-up radio operation information, and transmit the control field in a MAC header of a frame over the wireless communication link.

A non-transitory computer readable medium for wireless communication is described. The non-transitory computer-readable medium may include instructions operable to cause a processor to establish a wireless communication link between a station and an access point, the station including a main radio and a wake-up radio, populate a control field with wake-up radio operation information, and transmit the control field in a MAC header of a frame over the wireless communication link.

In some examples of the method, apparatus, and non-transitory computer-readable medium described above, transmitting the control field comprises: transmitting the control field in the MAC header of a data frame.

Some examples of the method, apparatus, and non-transitory computer-readable medium described above may further include processes, features, means, or instructions for identifying that data may be buffered for transmission. Some examples of the method, apparatus, and non-transitory computer-readable medium described above may further include processes, features, means, or instructions for determining to populate the control field with wake-up radio operation information based on the data being buffered for transmission.

In some examples of the method, apparatus, and non-transitory computer-readable medium described above, populating the control field comprises: including in the control field a wake-up schedule of a receiver of the wake-up radio. In some examples of the method, apparatus, and non-transitory computer-readable medium described above, including in the control field a wake-up schedule comprises including, in the control field, a wake-up interval, a wake-up duration, an indication that the receiver of the wake-up radio may be in a constant wake-up mode, or combinations thereof.

In some examples of the method, apparatus, and non-transitory computer-readable medium described above, including in the control field a wake-up schedule comprises: including in the control field a timing offset between receipt of a wake-up radio beacon from the access point and a wake-up window of the station.

In some examples of the method, apparatus, and non-transitory computer-readable medium described above, populating the control field comprises including in the control field a transmission schedule of a wake-up radio beacon of the access point. In some examples of the method, apparatus, and non-transitory computer-readable medium described above, including in the control field a transmission schedule comprises including in the control field a wake-up radio beacon start time, a wake-up radio beacon interval, or combinations thereof.

In some examples of the method, apparatus, and non-transitory computer-readable medium described above, populating the control field comprises: including in the control field a wake-up radio operation frequency band, a wake-up radio modulation and coding scheme (MCS), or combinations thereof. In some examples of the method, apparatus, and non-transitory computer-readable medium described above, populating the control field comprises including in the control field a wake-up radio mode indicator of the station indicating that the station may be to enter a wake-up radio mode.

In some examples of the method, apparatus, and non-transitory computer-readable medium described above, populating the control field comprises including in the control field a station identification to be included in a wake-up packet for the station.

In some examples of the method, apparatus, and non-transitory computer-readable medium described above, populating the control field comprises including in the control field a wake-up packet acknowledgment timeout interval indicating an amount of time that the access point will wait to receive a packet from the station after transmission of a wake-up packet.

In some examples of the method, apparatus, and non-transitory computer-readable medium described above, populating the control field comprises including in the control field an amount of time by which the station may be able to turn on the main radio from a sleep mode.

A method of wireless communication is described. The method may include establishing a wireless communication link with a station that includes a main radio and a wake-up radio, transmitting a wake-up packet to the station, and awaiting an acknowledgement timeout interval for reception of an acknowledgement of the wake-up packet from the station, the acknowledgement timeout interval being a function of pending traffic between the access point and the station.

An apparatus for wireless communication is described. The apparatus may include means for establishing a wireless communication link with a station that includes a main radio and a wake-up radio, means for transmitting a wake-up packet to the station, and means for awaiting an acknowledgement timeout interval for reception of an acknowledgement of the wake-up packet from the station, the acknowledgement timeout interval being a function of pending traffic between the access point and the station.

Another apparatus for wireless communication is described. The apparatus may include a processor, memory in electronic communication with the processor, and instructions stored in the memory. The instructions may be operable to cause the processor to establish a wireless communication link with a station that includes a main radio and a wake-up radio, transmit a wake-up packet to the station, and await an acknowledgement timeout interval for reception of an acknowledgement of the wake-up packet from the station, the acknowledgement timeout interval being a function of pending traffic between the access point and the station.

A non-transitory computer readable medium for wireless communication is described. The non-transitory computer-readable medium may include instructions operable to cause a processor to establish a wireless communication link with a station that includes a main radio and a wake-up radio, transmit a wake-up packet to the station, and await an acknowledgement timeout interval for reception of an acknowledgement of the wake-up packet from the station, the acknowledgement timeout interval being a function of pending traffic between the access point and the station.

Some examples of the method, apparatus, and non-transitory computer-readable medium described above may further include processes, features, means, or instructions for reducing the acknowledgement timeout interval as a priority of the pending traffic increases. Some examples of the method, apparatus, and non-transitory computer-readable medium described above may further include processes, features, means, or instructions for adjusting the acknowledgement timeout interval based at least in part on a quality of service requirement, wherein the quality of service requirement may be at least a portion of the function of pending traffic.

In some examples of the method, apparatus, and non-transitory computer-readable medium described above, the quality of service requirement may be based at least in part on whether the pending traffic between the access point and the station corresponds to real-time or non-real-time application.

In some examples of the method, apparatus, and non-transitory computer-readable medium described above, the quality of service requirement may be based at least in part on an access category or a user priority of pending traffic between the access point and the station. In some examples of the method, apparatus, and non-transitory computer-readable medium described above, the quality of service requirement may be based at least in part on one or more quality of service parameters of pending traffic between the access point and the station. In some examples of the method, apparatus, and non-transitory computer-readable medium described above, the one or more quality of service parameters include a range of delay bound specified in a traffic specification element per quality of service traffic flow.

Some examples of the method, apparatus, and non-transitory computer-readable medium described above may further include processes, features, means, or instructions for determining respective acknowledgement timeout intervals for each of multiple concurrent traffic flows. Some examples of the method, apparatus, and non-transitory computer-readable medium described above may further include processes, features, means, or instructions for adjusting the acknowledgement timeout interval based on a shortest of the respective acknowledgement timeout intervals.

A method of wireless communication is described. The method may include establishing a wireless communication link with a station that includes a main radio and a wake-up radio, determining a number of wake-up packets to transmit to the station, the number of wake-up packets being a function of pending traffic between the access point and the station, and transmitting the wake-up packets to the station until an acknowledgement is received from the station or the determined number of wake-up packets is transmitted.

An apparatus for wireless communication is described. The apparatus may include means for establishing a wireless communication link with a station that includes a main radio and a wake-up radio, means for determining a number of wake-up packets to transmit to the station, the number of wake-up packets being a function of pending traffic between the access point and the station, and means for transmitting the wake-up packets to the station until an acknowledgement is received from the station or the determined number of wake-up packets is transmitted.

Another apparatus for wireless communication is described. The apparatus may include a processor, memory in electronic communication with the processor, and instructions stored in the memory. The instructions may be operable to cause the processor to establish a wireless communication link with a station that includes a main radio and a wake-up radio, determine a number of wake-up packets to transmit to the station, the number of wake-up packets being a function of pending traffic between the access point and the station, and transmit the wake-up packets to the station until an acknowledgement is received from the station or the determined number of wake-up packets is transmitted.

A non-transitory computer readable medium for wireless communication is described. The non-transitory computer-readable medium may include instructions operable to cause a processor to establish a wireless communication link with a station that includes a main radio and a wake-up radio, determine a number of wake-up packets to transmit to the station, the number of wake-up packets being a function of pending traffic between the access point and the station, and transmit the wake-up packets to the station until an acknowledgement is received from the station or the determined number of wake-up packets is transmitted.

Some examples of the method, apparatus, and non-transitory computer-readable medium described above may further include processes, features, means, or instructions for increasing the number of wake-up packets as a priority of the pending traffic increases. Some examples of the method, apparatus, and non-transitory computer-readable medium described above may further include processes, features, means, or instructions for adjusting the number of wake-up packets based at least in part on a quality of service requirement, wherein the quality of service requirement may be at least a portion of the function of pending traffic.

In some examples of the method, apparatus, and non-transitory computer-readable medium described above, the quality of service requirement may be based at least in part on whether the pending traffic between the access point and the station corresponds to real-time or non-real-time application. In some examples of the method, apparatus, and non-transitory computer-readable medium described above, the quality of service requirement may be based at least in part on an access category or a user priority of pending traffic between the access point and the station.

In some examples of the method, apparatus, and non-transitory computer-readable medium described above, the quality of service requirement may be based at least in part on one or more quality of service parameters of pending traffic between the access point and the station. In some examples of the method, apparatus, and non-transitory computer-readable medium described above, the one or more quality of service parameters include a range of delay bound specified in a traffic specification element per quality of service traffic flow.

### BRIEF DESCRIPTION OF THE DRAWINGS

FIG. 1 illustrates an example of a system for wireless communication that supports wakeup radio (WUR) mode high efficiency (HE) control field design and wakeup frame transmission techniques in accordance with aspects of the present disclosure.

FIG. 2 illustrates an example of a wireless communications system that supports WUR mode HE control field design and wakeup frame transmission techniques in accordance with aspects of the present disclosure.

FIG. 3 illustrates an example of a transmission format that supports the transmission of WUR information.

FIG. 4 illustrates an example of a transmission format that supports WUR mode HE control field design and wakeup frame transmission techniques in accordance with aspects of the present disclosure.

FIGS. 5 through 7 illustrate examples of process flows that support WUR mode HE control field design and wakeup frame transmission techniques in accordance with aspects of the present disclosure.

FIGS. 8 through 10 show block diagrams of a device that supports WUR mode HE control field design and wakeup frame transmission techniques in accordance with aspects of the present disclosure.

FIG. 11 illustrates a block diagram of a system including a station (STA) that supports WUR mode HE control field design and wakeup frame transmission techniques in accordance with aspects of the present disclosure.

FIGS. 12 through 14 show block diagrams of a device that supports WUR mode HE control field design and wakeup frame transmission techniques in accordance with aspects of the present disclosure.

FIG. 15 illustrates a block diagram of a system including an access point (AP) that supports WUR mode HE control field design and wakeup frame transmission techniques in accordance with aspects of the present disclosure.

FIGS. 16 through 20 illustrate methods for WUR mode HE control field design and wakeup frame transmission techniques in accordance with aspects of the present disclosure.

### DETAILED DESCRIPTION

A wireless device may have a limited amount of battery power. In some cases, it may be beneficial for a primary radio (e.g., of a wireless device) to remain in a sleep mode or low power mode for extended periods of time. During a sleep mode, a wireless device may periodically activate a low-power radio (e.g., a wakeup radio (WUR)) to listen for and decode a wakeup signal (e.g., wakeup transmissions) from an access point (AP), to trigger activation of the primary radio.

Exchange of WUR operation related information via WUR mode information elements (IEs) may use separate (e.g., additional) action frames such as a WUR action frame. Such WUR dedicated action frames for exchange of information relating to WUR operation between wireless devices may increase system overhead. To reduce such overhead, a high throughput (HT) control field of a media access control (MAC) header may be configured as a WUR mode high efficiency (HE) control field such that WUR operation related information may be piggybacked over (e.g., transmitted with) data. Therefore, any transmission frames that include a MAC header (e.g., data frames, management frames, etc.) may convey WUR operation information, reducing the use of WUR dedicated action frames (e.g., which may be associated with additional system overhead).

Further, WUR acknowledgement timeout intervals may not account for traffic types or quality of service (QoS) requirements of pending or buffered data. To reduce latency associated with wakeup packet retransmissions and their associated timeout intervals, a number of successive wakeup packet transmissions and/or timeout interval durations may be a function of QoS requirements associated with pending or buffered traffic. That is, time sensitive (e.g., critical) pending traffic may be associated with shorter timeout intervals to avoid latency associated with long wakeup packet retransmissions (e.g., associated with longer timeout intervals). Additionally or alternatively, to increase reliability, a wireless device (e.g., an AP) may successively transmit multiple wakeup packets as a function of a characteristic of the pending data, such as QoS requirements associated with the pending data. As such, the traffic type or QoS requirements associated with pending traffic may influence the timeout interval and/or number of successive wakeup packet transmissions to increase reliability of wakeup packet transmissions and/or reduce latency associated with wakeup packet retransmissions.

Aspects of the disclosure are initially described in the context of a wireless communications system. Example transmission formats and process flows relating to discussed control field designs and wakeup frame transmission techniques are then described. Aspects of the disclosure are further illustrated by and described with reference to apparatus diagrams, system diagrams, and flowcharts that relate to WUR mode HE control field design and wakeup frame transmission techniques.

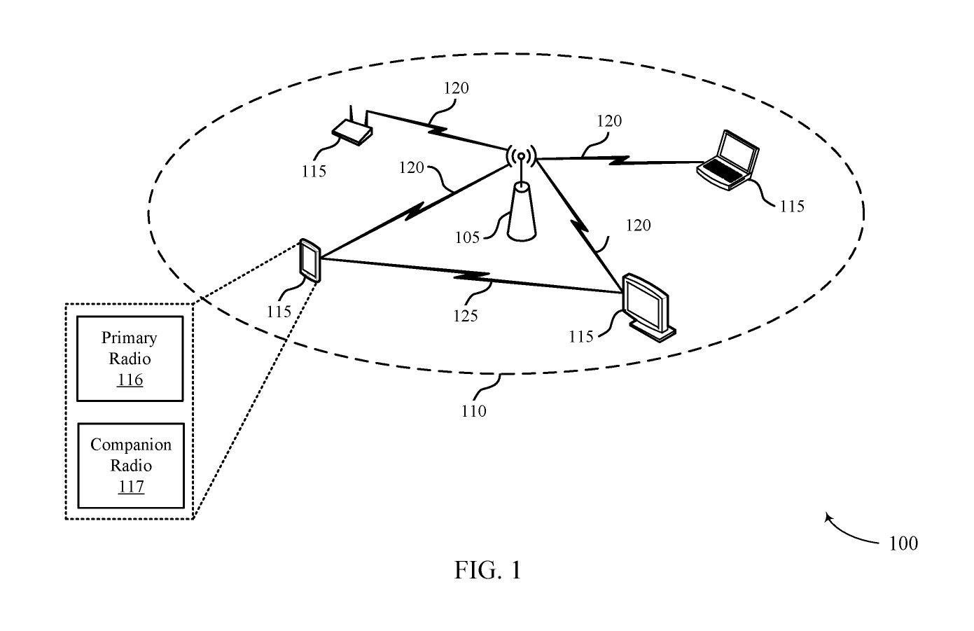

FIG. 1 illustrates a wireless local area network (WLAN) 100 (also known as a Wi-Fi network) configured in accordance with various aspects of the present disclosure. The WLAN 100 may include an AP 105 and multiple associated stations (STAs) 115, which may represent devices such as wireless communication terminals, including mobile stations, phones personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS. WLAN 100 may support media access control for wakeup radio.

A STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and MAC layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc.

In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands, such as shared licensed frequency bands, where multiple operators may have a license to operate in the same or overlapping frequency band or bands.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

A STA 115 may include a primary radio 116 and a low power companion radio 117 for communication. The primary radio 116 may be used during active modes (e.g., full power modes) or for high-data throughput applications. A low-power companion radio 117 may be used during low-power modes or for low-throughput applications. In some examples, the low-power companion radio 117 may be a WUR or a wakeup receiver radio.

A STA 115 may listen using a WUR, such as companion radio 117, for a wakeup message or wakeup frame in a wakeup waveform. In some cases, STA 115 may receive a preamble having a first frequency band (e.g., wideband, such as on a 20 MHz channel) and a wakeup signal (e.g., a WUR signal) having a second frequency band (e.g., narrowband, such as a 4-5 MHz channel within the 20 MHz channel). Further, the companion radio 117 may share the same medium (e.g., frequency spectrum targeted for reception) as primary radio 116. However, transmissions intended for companion radio 117 may be associated with lower data rates (e.g., tens or hundreds of kbps).

WLAN 100 may support WUR mode HE control fields such that WUR operation related information may be piggybacked over (e.g., transmitted with) data such that any transmission frame that includes a MAC header (e.g., data frames, management frames, etc.) may convey WUR operation information, as further described below. Further, a number of successive wakeup packet transmissions and/or timeout interval durations as a function of QoS requirements associated with pending or buffered traffic may be implemented within WLAN 100.

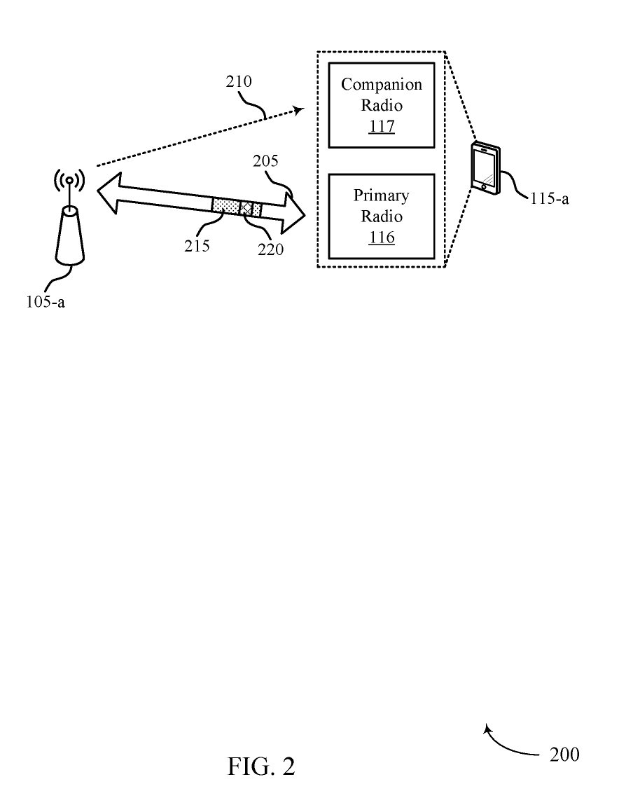

FIG. 2 illustrates an example of a WLAN 200 that supports WUR mode HE control field design and wakeup frame transmission techniques in accordance with various aspects of the present disclosure. In some examples, WLAN 200 may implement aspects of WLAN 100. WLAN 200 may include an AP 105-a and a STA 115-a which may be examples of the corresponding devices described with reference to FIG. 1. STA 115-a may include a primary radio 116 and a companion radio 117 (e.g., a WUR) for communication.

The primary radio 116 may be used during active modes or for high-data throughput applications (e.g., for full power transmissions 205 from AP 105-a). The low-power companion radio 117 may be used during low-power modes or for low-throughput applications (e.g., for wakeup transmissions 210 from AP 105-a). A STA 115 may receive wakeup transmissions and power additional circuitry (e.g., primary radio 116). In some examples, the low-power companion radio 117 may be a WUR. The companion radio 117 may listen for wakeup transmissions 210 (e.g., WUR beacons) and wakeup the primary radio 116 of STA 115-a for primary communications (e.g., full power, high-data throughput applications).

To configure STA 115-a operation of the low-power companion radio 117 (e.g., the WUR), AP 105-a and STA 115-a may exchange WUR operation information via primary radio 116 (e.g., using full power transmissions 205). Full power transmissions 205 may include data transmissions, management frames, etc. According to techniques described herein, full power transmissions 205 may include MAC headers that contain HE control fields 215, and HE control fields 215 may include WUR operation information 220. An AP 105-a and/or STA 115-a may populate HE control fields 215 with such WUR operation information 220, and may transmit the HE control fields 215 in MAC headers associated with full power transmissions 205. The WUR operation information may include, for example, a time for powering a main radio (e.g., a primary radio 116 of STA 115-a), a duty-cycle of a WUR, etc.

As STA 115-a operates a WUR (e.g., according to exchanged WUR operation information), the STA 115-a may acknowledge or confirm reception of received wakeup packets (e.g., unicast wakeup packets received via wakeup transmissions 210). Accordingly, AP 105-a may wait a timeout interval, after transmitting a wakeup packet, to receive a packet (e.g., an acknowledgment) from STA 115-a. If the AP 105-a receives a packet from the STA 115-a within the timeout interval, the received packet may acknowledge successful reception of the wakeup packet by the STA 115-a. If the AP 105-a transmits a wakeup packet to the STA 115-a and the timeout interval expires without the AP 105-a receiving a packet from the STA 115-a in response, the AP 105-a may determine the wakeup transmission has failed, and may retransmit the wakeup packet to the STA 115-a. Therefore, the timeout interval may be configured to allow enough time for the STA 115-a to wakeup the primary radio and transmit a response packet (e.g., an acknowledgment) via full power transmissions 205. For example, the timeout interval may be configured based on the exchanged WUR operation information discussed above.

Further, timeout intervals may be differentiated for different traffic types (e.g., traffic associated with different QoS requirements). AP 105-a may transmit a wakeup packet to STA 115-a, and may wait for an acknowledgment during a time period associated with a timeout interval that is a function of a QoS requirement of pending traffic (e.g., that initiated transmission of the wakeup packet). For example, if pending traffic at AP 105-a is associated with a high priority access category, the AP 105-a may wait a shorter timeout interval before retransmitting a wakeup packet (e.g., if no acknowledgment it received). Waiting a shorter timeout interval (e.g., for time sensitive pending traffic) prior to wakeup packet retransmission may reduce wakeup packet retransmission latency in the case of initial wakeup packet transmission failure.

In some cases (e.g., delay sensitive scenarios), AP 105-a may transmit more than one wakeup packet successively (e.g., repeated duplicate wakeup packet transmissions) to increase reliability of a successful transmission of a wakeup packet. In such cases, if the same wakeup packet is transmitted within the existing timeout interval of a previous wakeup transmission (e.g., successive transmissions within a timeout interval), a new timeout interval may be established to replace the existing timeout interval. For example, the latest or most recent wakeup packet transmission of multiple successive wakeup packet transmissions may be used as the base or beginning of a timeout interval observed by AP 105-a (e.g., timeout interval is extended with each successive transmission). Therefore, successive wakeup packet transmissions may reduce the likelihood of wakeup packet retransmissions (e.g., after an expired timeout interval), as the likelihood of successful reception of one of the multiple duplicates is increased. Such successive wakeup packet transmissions may thus be used for critical pending data (e.g., delay sensitive scenarios), where an AP 105-a attempts to wakeup STA 115-a as soon as possible to receive the critical data via full power transmissions 205, as latencies associated with timeout intervals and wakeup packet retransmissions may be reduced.

Further, AP 105-a may determine a number of successive wakeup packets to transmit based on QoS requirements of pending traffic. That is, the number of successive wakeup packet transmissions may be a function of QoS requirements of the pending traffic. For example, the higher the priority access category of pending data, the more successive wakeup packets AP 105-a may transmit in order to increase the reliability of a wakeup packet being received successfully by STA 115-a (e.g., reducing the probability of needing a retransmission of the wakeup packet after a timeout interval, thus reducing latency associated with transmitting the high priority pending data).

QoS requirements associated with pending traffic at AP 105-a may be classified according to a type of pending traffic flow, an access category, QoS parameters, etc. For example, QoS requirements may be classified based on real-time (e.g., resulting in shorter timeout values) or non-real-time (e.g., resulting in more lenient timeout values) of pending traffic flow. Further, an access category or user priority of pending traffic flow may be taken into account to determine timeout values (e.g., the higher the access category, the lower the resulting timeout interval and/or the more successive wakeup packet transmissions). Additionally, QoS parameters for pending traffic flow (e.g., a range of delay bound specified in traffic specification (TSPEC) element per QoS traffic flow) may be used to determine timeout values. For example, each delay range associated with different QoS parameters of different pending traffic flows may be associated with a timeout interval (e.g., shorter indicated delay ranges may result in shorter timeout values or an increased number of successive wakeup packet transmissions). If multiple pending traffic flows exist at AP 105-a, AP 105-a may determine a timeout interval according to the shortest timeout interval associated with the different traffic flows. Generally, scenarios described above calling for shorter timeout values also call for increased number of successive wakeup packet transmissions. Exceptions may occur. Implementation of such techniques (e.g., techniques for determining timeout intervals and techniques for determining a number of successive transmissions) may occur independent of each other, or in other cases, such techniques may be performed jointly.

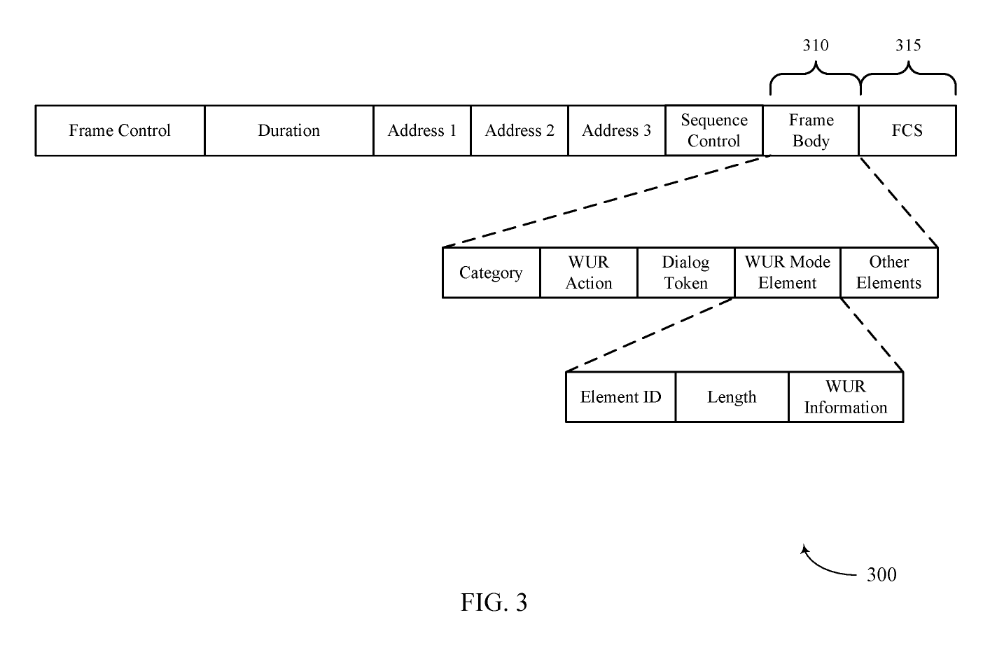

FIG. 3 illustrates an example of a transmission frame 300 that supports transmission of WUR information. In some examples, transmission frame 300 may implement aspects of WLAN 100 and WLAN 200. In some cases, transmission frame 300 may refer to an action frame which may, in some cases, include a frame body 310 and a frame check sequence (FCS) 315. Transmission frames 300 may be used by STAs 115 and/or APs 105 via main radio or primary radio communication to configure WUR operation at a STA 115.

Frame body 310 may refer to a frame body field that includes a category field (e.g., 1 octet), a WUR action field (e.g., 1 octet), a dialog token field (e.g., 1 octet), a WUR mode element, as well as other elements or fields. The frame body 310 may therefore be a variable number of octets depending on the elements included in the field. In some cases, transmission frame 300 may resemble aspects of an 802.11ax WUR action frame. The transmission frame 300 may be used for exchanging WUR operation related information. Specifically, transmission frame 300 may include an element ID field (e.g., 1 octet), a length field (e.g., 1 octet), and WUR information within the WUR mode element of the frame body 310. The WUR information may include, for example, a time for powering a main radio, a duty-cycle of a WUR, etc. and may use a variable number of octets, depending on the information included.

In the example of transmission frame 300, the WUR mode information element may be carried in a WUR action frame (e.g., for the exchange of WUR related information between STAs 115 and APs 105). That is, WUR operation information may be carried in separate WUR action frames (e.g., separate from other transmissions such as data, management frames, etc.). As mentioned above, the WUR operation information may include a required amount of time for powering or turning on a primary radio of the STA 115, the duty-cycle of a WUR of the STA 115, as well as other WUR operation relating information. APs 105 may use information such as the time required for an STA 115 to power up a primary radio to determine the earliest time the STA 115 may receive full power transmissions (e.g., primary radio communications) after receiving a wakeup transmission (e.g., a wakeup packet). For example, such information may indicate to APs 105 a time period after which the AP may expect to receive an acknowledgment or confirmation (e.g., via a STA 115 primary radio transmission) in response to a wakeup packet transmitted to the STA 115. Further, APs 105 may use exchange duty-cycle information (e.g., an interval or frequency of WUR active or listening periods) to determine when or how often to send wakeup packets to the STA 115. That is, duty-cycle information may indicate an interval between WUR on periods, as well as a duration of each WUR on period, such that an AP may transmit any wakeup packets accordingly.

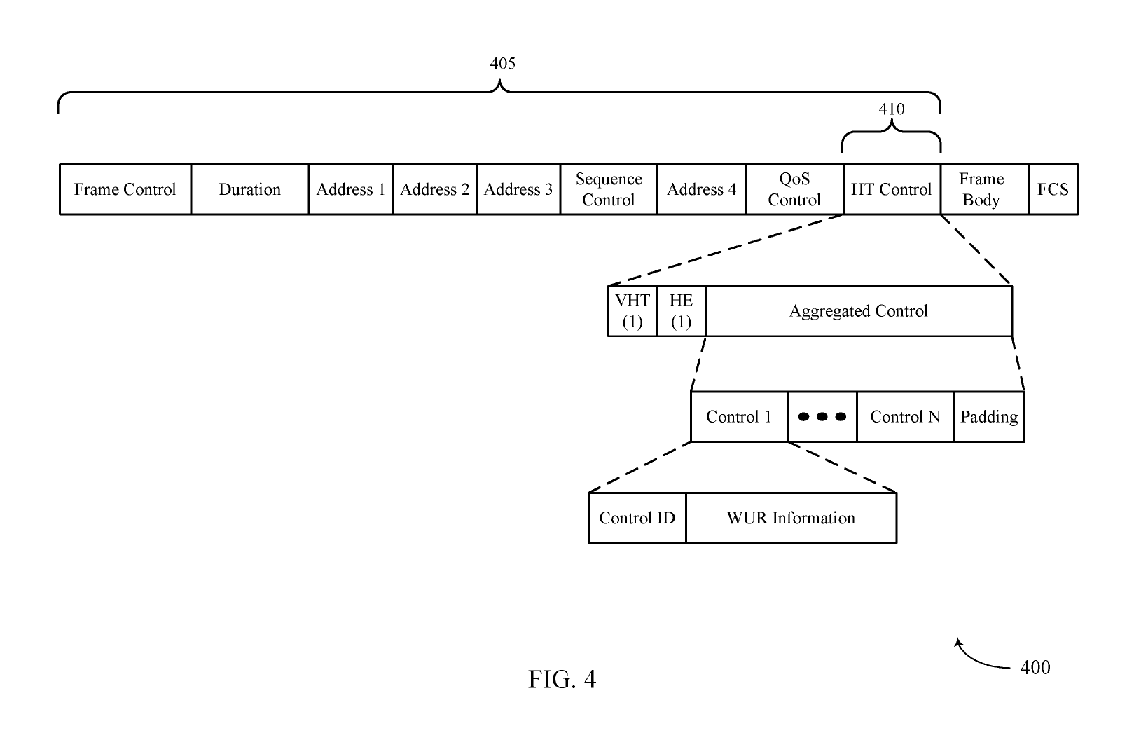

FIG. 4 illustrates an example of a transmission frame 400 that supports WUR mode HE control field design and wakeup frame transmission techniques in accordance with various aspects of the present disclosure. In some examples, transmission frame 400 may implement aspects of WLAN 100. In some cases, transmission frame 400 refer to a data frame and may, in some examples, include a MAC header 405, a frame body, and a FCS. The MAC header 405 may include, for example, similar fields to those discussed with reference to MAC header 305 of FIG. 3. Transmission frames 400 may be used by STAs 115 and/or APs 105 via main radio or primary radio communication to configure WUR operation at a STA 115.

In the present example, a MAC header 405 may include fields such as a frame control field (e.g., 2 octets), a duration field (e.g., 2 octets), address fields (e.g., address 1, address 2, and address 3 fields, 6 octets each), and a sequence control field (e.g., 2 octets), an address 4 field, a QoS control field, and a HT control field (e.g., 0 or 4 octets).

MAC header 405 may include a HT control field 410. In the present example, HT control field 410 may refer to a WUR mode HE control field as further described herein. HT control field 410 may include two toggle bits to indicate the HT control field 410 is an HE variant HT control field. Specifically, a very high throughput (VHT) indication bit and/or an HE indication bit may be set to ‘1’. Following the variant indication toggle bits, the HT control field may include an aggregated control field. The aggregated control field may include multiple control fields, and in some cases, additional padding to fill the remainder of the aggregated control field. A control field within the aggregated control field may include, for example, a control identification (ID) followed by control information. Therefore, the HT control field 410 may carry multiple control subfields identified by different control IDs. The control ID may be used to differentiate the WUR mode HE control field from other HE variant HT control fields. The HT control field 410 may be included in the MAC header 405 of any frame, and control information (e.g., transmission/reception operation parameters) may be piggybacked over (e.g., transmitted with) data. APs 105 and/or STAs 115 that wish to update such control information may send a transmission with an updated control subfield to other devices to indicate updated operation parameters, such that a separate frame is not needed to convey such information.

According to the present disclosure, a control field within aggregated control field of the HT control field 410 (e.g., HE variant HT control field or WUR mode HE control field) may include WUR operation related information as shown. In such cases, the WUR operation information may be included in the MAC header 405. Therefore, transmission frame 400 may not necessarily be a WUR action frame. In fact, transmission frame 400 may refer to a data frame, a control frame, or any transmission frame that includes a MAC header. As such, overhead related to explicit WUR action frames may be reduced, and increased flexibility in transmissions used for exchange of WUR operation information may be achieved.

A WUR mode HE control field (e.g., HE variant HT control field 410 that includes WUR operation information) may carry WUR operation related information via transmission frames over the main radio of a STA 115 and/or AP 105. As such, WUR operation information (e.g., the WUR mode HE control field) may be piggybacked over any possible frame transmitted over a main radio. In some cases, the WUR mode HE control field may be used instead of a WUR dedicated action frame. In other cases, the WUR mode HE control field may be used in conjunction with the WUR dedicated action frame to convey additional WUR operation information.

In some cases, STAs 115 and APs 105 may include different WUR operation information in their respective transmissions. For example, WUR operation information transmitted by STAs 115 may include WUR wakeup schedules, timing offsets, STA WUR mode indications, required time to power up a main radio, etc. A wakeup schedule of the STAs WUR may include a wakeup interval and a wakeup duration (e.g., of WUR active periods), such that an AP 105 may transmit wakeup packets accordingly. Alternatively, the WUR wakeup schedule may indicate the WUR is always on, such that an AP 105 may transmit wakeup packets at any time. Further, the WUR wakeup schedule may indicate a timing offset between the APs WUR beacon and the STA's next wakeup window. STA WUR mode indications may inform an AP 105 that the STA 115 is entering a WUR operation mode (e.g., powering down a primary radio and powering up a WUR radio according to the indicated WUR wakeup schedule). As discussed above, the required time to power up the main radio may also be indicated by the STA 115 via WUR operation information, such that an AP 105 may appropriately determine a timeout interval such that the STA 115 has enough time to power up a primary radio and transmit an acknowledgment of a received wakeup packet (e.g., via the primary radio).

Further, WUR operation information transmitted by APs 105 may include a WUR beacon transmission schedule, frequency bands for WUR operation, a WUR modulation coding scheme (MCS), allocated STA IDs used within the wakeup packet, WUR acknowledgement timeout intervals, etc. For example, WUR beacon transmission schedules may indicate a beacon interval and a subsequent beacon start time, such that a STA 115 may monitor for WUR beacons accordingly (e.g., STA 115 may, in some cases, set a WUR duty-cycle based on a received WUR beacon transmission schedule). Additionally, wakeup packet acknowledgement timeout intervals may be indicated via WUR operation information such that STAs 115 may be aware of the timeout interval, and attempt to transmit acknowledgments to received wakeup packets before the interval expires.

Although different WUR operation information is described above with reference to transmissions from either a STA 115 or an AP 105, either wireless device (e.g., a STA 115 or an AP 105) may transmit any or all of the WUR operation information detailed above. For example, an AP 105 may instead transmit a desired WUR wakeup schedule to a STA 115 via WUR operation information, such that the STA 115 may adopt the indicated WUR wakeup schedule. Similarly, a STA 115 may indicate a necessary wakeup packet acknowledgment timeout interval (e.g., based on a time period associated with powering a primary radio) to the AP 105. In yet other cases, a STA 115 or an AP 105 may indicate or confirm all WUR operation information via a WUR mode HE control field for WUR operation at the STA 115. Note that an AP 105 (e.g., a mobile AP operating with battery) may also enter a WUR mode to save power, and STAs 115 may send WUR wakeup frames to inform the AP 105 to power up its main radio.

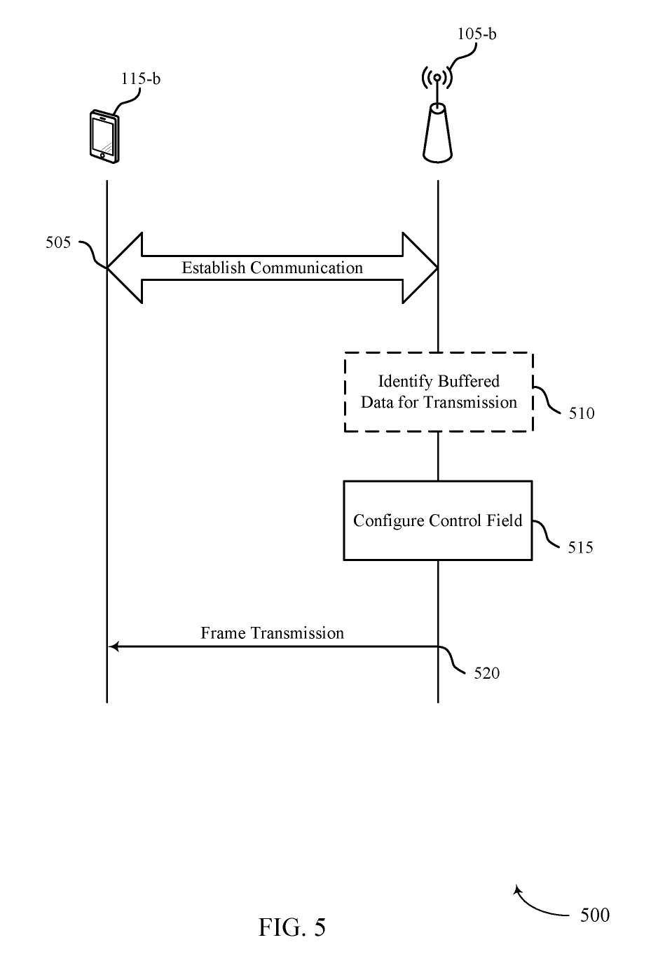

FIG. 5 illustrates an example of a process flow 500 that supports WUR mode HE control field design and wakeup frame transmission techniques in accordance with various aspects of the present disclosure. In some examples, process flow 500 may implement aspects of WLAN 100 and WLAN 200. Process flow 500 may include STA 115-b and AP 105-b, which may be examples of the corresponding devices described with reference to FIGS. 1-2. STA 115-b may include a primary radio 116 (e.g., a main radio) and a companion radio 117 (e.g., a WUR) for communication.

At step 505, AP 105-b and STA 115-b may establish a wireless communication link, where the STA 115-b includes a main radio (e.g., a primary radio) and a wakeup radio (e.g., a WUR).

At step 510, AP 105-b may identify that data is buffered for transmission (e.g., traffic is pending for STA 115-b). For example, between steps 505 and 510, STA 115-b may enter a WUR mode of operation (e.g., power down a primary radio and power up a WUR), after which AP 105-b may identify buffered data.

At step 515, AP 105-b may populate a control field with WUR operation information. In some cases, the control field may be populated based on the data buffered for transmission identified at step 510. Populating the control field may refer to including the control field in a wakeup schedule of a receiver of the WUR (e.g., including a wakeup interval, a wakeup duration, and/or an indication the WUR is in a constant active state in the control field. Further, including the control field in a wakeup schedule may refer to including in the control field a timing offset between receipt of a wake-up radio beacon from the access point and a wake-up window of the station. In other cases, the control field may include a WUR beacon schedule (e.g., a WUR beacon start time and/or a WUR beacon interval). The control field may further include a WUR operation frequency band, a WUR MCS, a STA ID to be included in the wakeup packet for STA 115-b, a packet acknowledgment timeout interval indicating an amount of time that the AP 105-b may wait to receive a packet from STA 115-b after transmission of the wakeup packet, an amount of time by which STA 115-b is able to turn on the main radio from a sleep mode, etc.

At step 520, AP 105-b may transmit the control field in a MAC header of a transmission frame (e.g., over the wireless communication link established at step 505). Process flow 500 is shown for illustrative purposes only. As discussed above, the frame transmission may additionally or alternatively by sent by STA 115-b, and the information included in the control field from either STA 115-b or AP 105-b may include some or all of the WUR operation information discussed above.

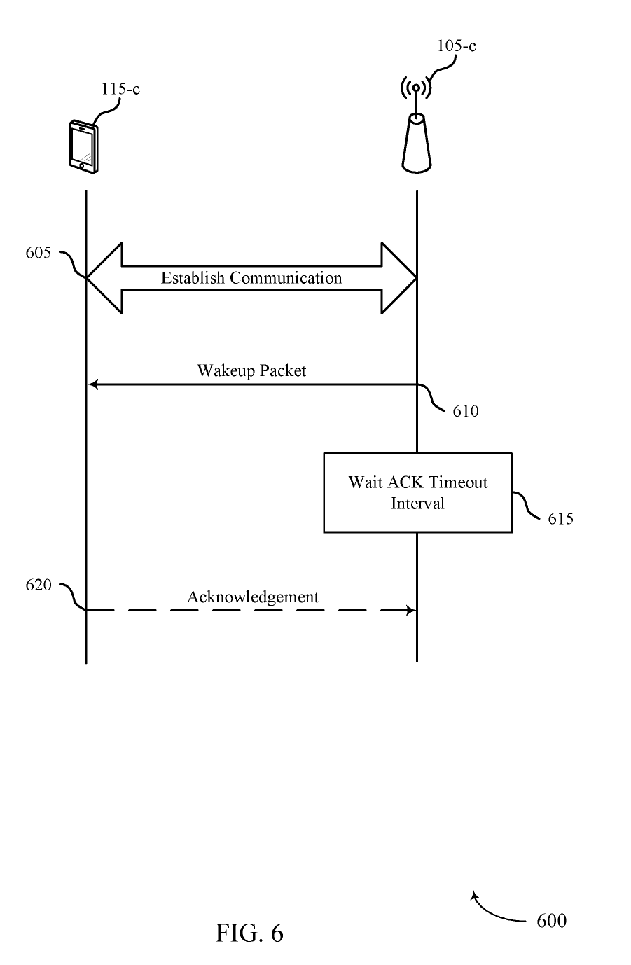

FIG. 6 illustrates an example of a process flow 600 that supports WUR mode HE control field design and wakeup frame transmission techniques in accordance with various aspects of the present disclosure. In some examples, process flow 600 may implement aspects of WLAN 100 and WLAN 200. Process flow 600 may include STA 115-c and AP 105-c, which may be examples of the corresponding devices described with reference to FIGS. 1-2. STA 115-c may include a primary radio 116 (e.g., a main radio) and a companion radio 117 (e.g., a WUR) for communication.

At step 605, AP 105-c and STA 115-c may establish a wireless communication link, where the STA 115-c includes a main radio (e.g., a primary radio) and a wakeup radio (e.g., a WUR).

At step 610, AP 105-c may transmit a wakeup packet to STA 115-c (e.g., in response to identifying pending traffic associated with the STA 115-c).

At step 615, AP 105-c may await an acknowledgement timeout interval for reception of an acknowledgement of the wakeup packet transmitted to the STA 115-c at step 610. The acknowledgement timeout interval may be a function of pending traffic between the AP 105-c and STA 115-c (e.g., a function of a QoS requirement associated with the pending traffic). In some cases AP 105-c may adjust the acknowledgment timeout interval based on a QoS requirement of the pending traffic. The QoS requirement may be based on whether the pending traffic between the AP 105-c and the STA 115-c corresponds to real-time or non-real-time application, an access category or a user priority of pending traffic between the AP 105-c and the STA 115-c, and/or one or more QoS parameters of pending traffic between the AP 105-c and the STA 115-c. The one or more QoS parameters may include a range of delay bound specified in a traffic specification element per QoS traffic flow. In some cases, AP 105-c may reduce the acknowledgement timeout interval as a priority of the pending traffic increases. Further, AP 105-c may determine acknowledgment timeout intervals for each of multiple pending traffic flows, and adjust the timeout interval based on the shortest of the respective timeout intervals.

At step 620, STA 115-c may or may not transmit an acknowledgement in response to the AP 105-c within the timeout interval (e.g., depending on whether or not the wakeup packet was accurately received).

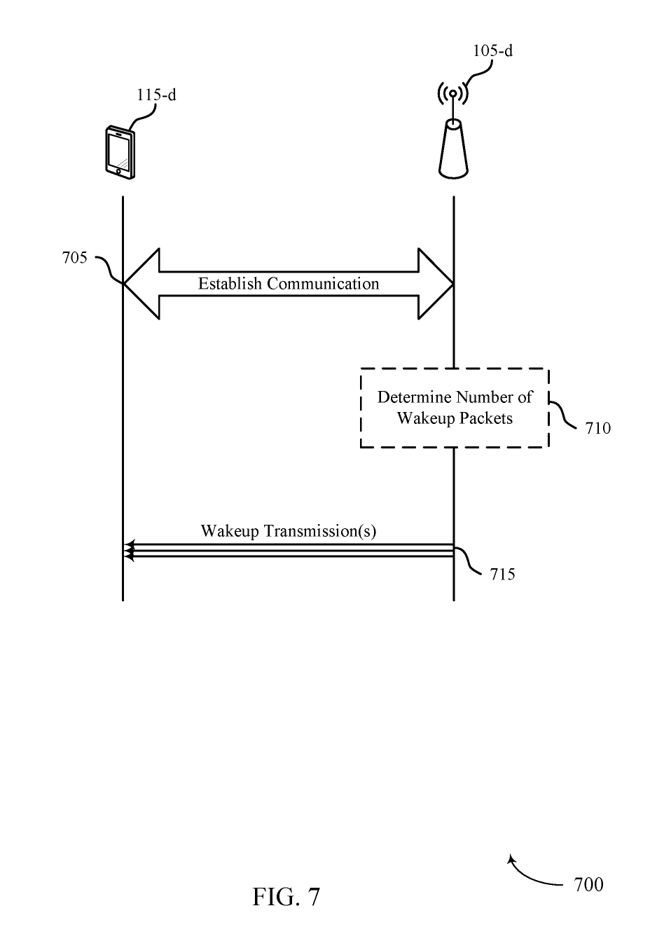

FIG. 7 illustrates an example of a process flow 700 that supports WUR mode HE control field design and wakeup frame transmission techniques in accordance with various aspects of the present disclosure. In some examples, process flow 700 may implement aspects of WLAN 100 and WLAN 200. Process flow 700 may include STA 115-d and AP 105-d, which may be examples of the corresponding devices described with reference to FIGS. 1-2. STA 115-d may include a primary radio 116 (e.g., a main radio) and a companion radio 117 (e.g., a WUR) for communication.

At step 705, AP 105-d and STA 115-d may establish a wireless communication link, where the STA 115-d includes a main radio (e.g., a primary radio) and a wakeup radio (e.g., a WUR).

At step 710, AP 105-d may determine a number of wakeup packets to transmit to STA 115-d. The number of wakeup packets may be determined according to a function of pending traffic between the AP 105-c and the STA 115-c. In some cases, the wakeup packets may be transmitted successively. In some cases, the number of wakeup packets may be increased as a priority of pending traffic increases. The number of wakeup packets may further be adjusted based on QoS requirements. The QoS requirement may be based on whether the pending traffic between the AP 105-d and the STA 115-d corresponds to real-time or non-real-time application, an access category or a user priority of pending traffic between the AP 105-d and the STA 115-d, and/or one or more QoS parameters of pending traffic between the AP 105-d and the STA 115-d. The one or more QoS parameters may include a range of delay bound specified in a traffic specification element per QoS traffic flow.

At step 715, AP 105-d may transmit the wakeup packets to STA 115-d until an acknowledgment is received from STA 115-d or until the determined number of wakeup packets are transmitted.

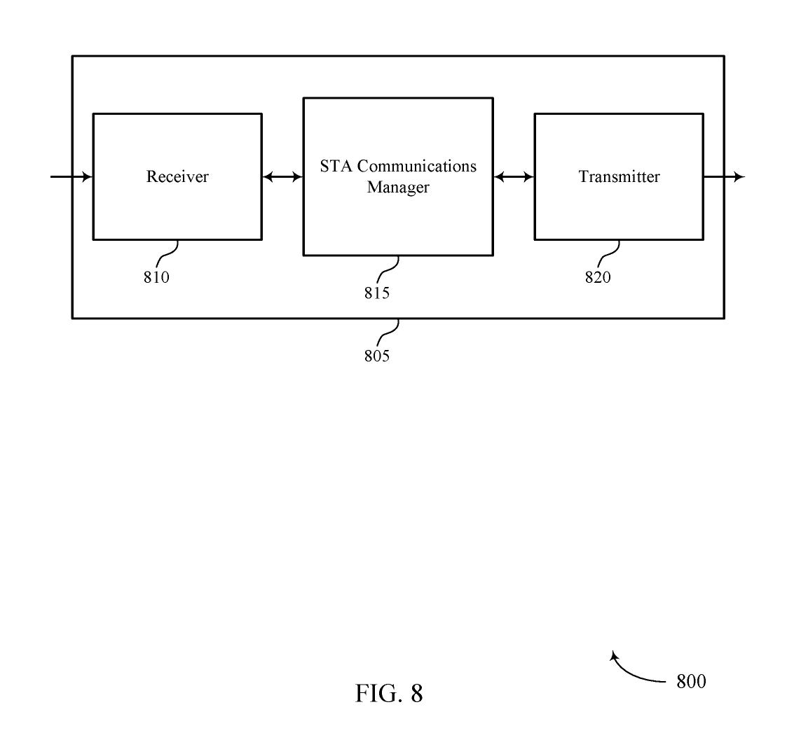

FIG. 8 shows a block diagram 800 of a wireless device 805 that supports WUR mode HE control field design and wakeup frame transmission techniques in accordance with aspects of the present disclosure. Wireless device 805 may be an example of aspects of a STA 115 as described herein. Wireless device 805 may include receiver 810, STA communications manager 815, and transmitter 820. Wireless device 805 may also include a processor. Each of these components may be in communication with one another (e.g., via one or more buses).

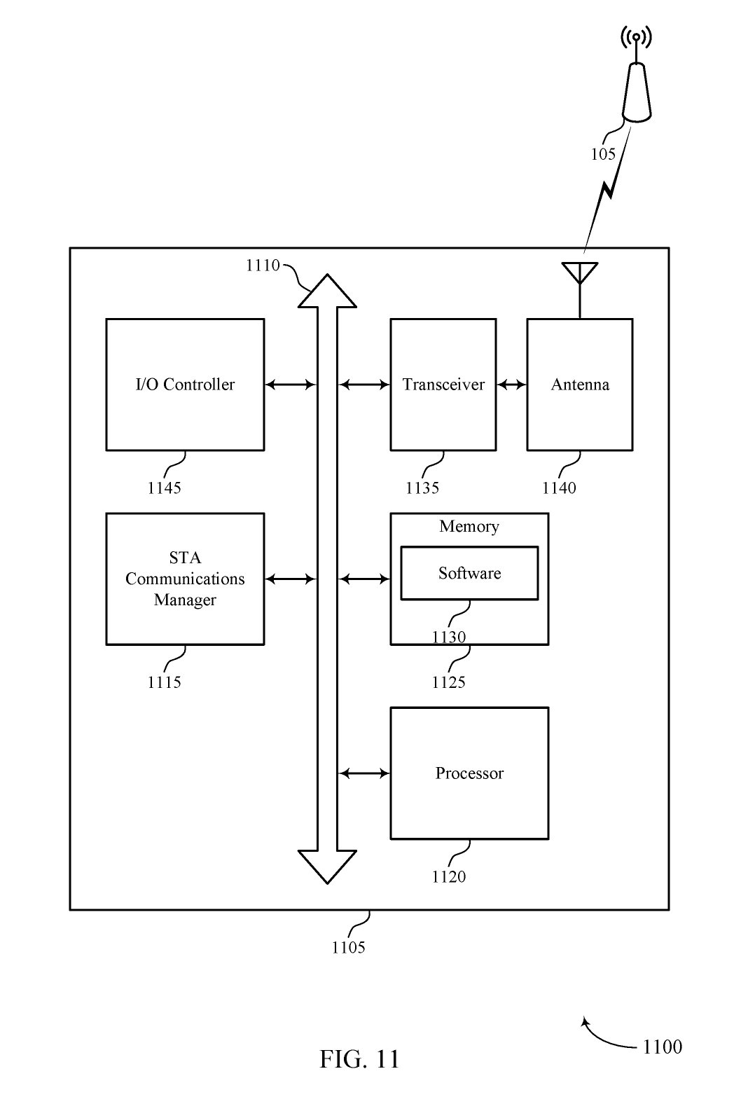

Receiver 810 may receive information such as packets, user data, or control information associated with various information channels (e.g., control channels, data channels, and information related to WUR mode HE control field design and wakeup frame transmission techniques, etc.). Information may be passed on to other components of the device. The receiver 810 may be an example of aspects of the transceiver 1135 described with reference to FIG. 11. The receiver 810 may utilize a single antenna or a set of antennas.

STA communications manager 815 may be an example of aspects of the STA communications manager 1115 described with reference to FIG. 11. STA communications manager 815 and/or at least some of its various sub-components may be implemented in hardware, software executed by a processor, firmware, or any combination thereof. If implemented in software executed by a processor, the functions of the STA communications manager 815 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The STA communications manager 815 and/or at least some of its various sub-components may be physically located at various positions, including being distributed such that portions of functions are implemented at different physical locations by one or more physical devices. In some examples, STA communications manager 815 and/or at least some of its various sub-components may be a separate and distinct component in accordance with various aspects of the present disclosure. In other examples, STA communications manager 815 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

STA communications manager 815 may establish a wireless communication link between a STA (e.g., including a main radio and a wakeup radio) and an AP, populate a control field with wakeup radio operation information, and transmit the control field in a MAC header of a frame over the wireless communication link.

Transmitter 820 may transmit signals generated by other components of the device. In some examples, the transmitter 820 may be collocated with a receiver 810 in a transceiver module. For example, the transmitter 820 may be an example of aspects of the transceiver 1135 described with reference to FIG. 11. The transmitter 820 may utilize a single antenna or a set of antennas.

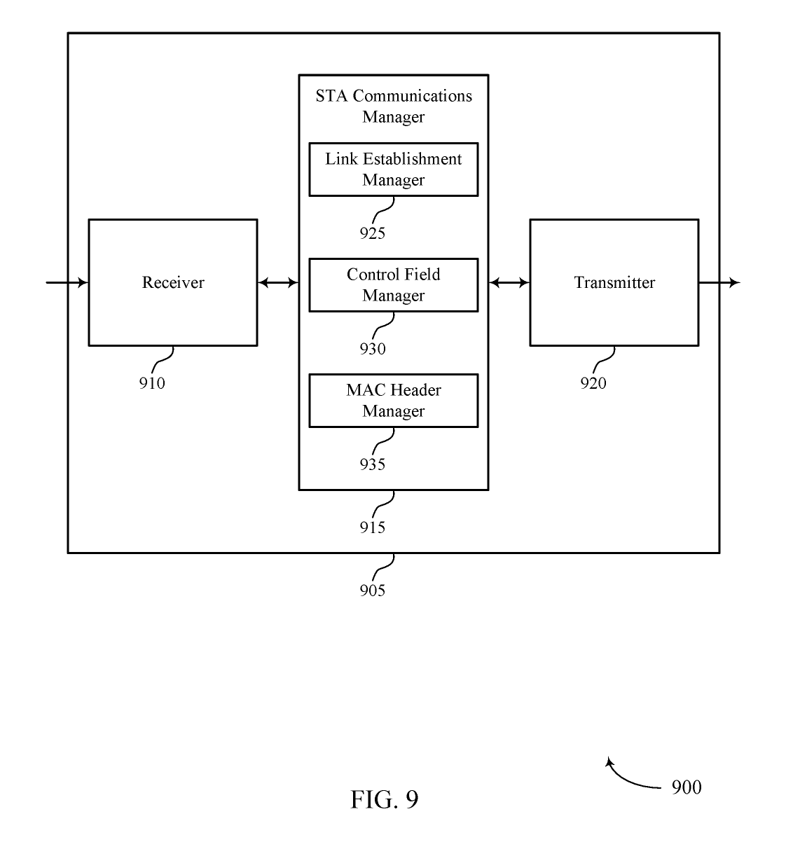

FIG. 9 shows a block diagram 900 of a wireless device 905 that supports WUR mode HE control field design and wakeup frame transmission techniques in accordance with aspects of the present disclosure. Wireless device 905 may be an example of aspects of a wireless device 805 or a STA 115 as described with reference to FIG. 8. Wireless device 905 may include receiver 910, STA communications manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to WUR mode HE control field design and wakeup frame transmission techniques, etc.). Information may be passed on to other components of the device. The receiver 910 may be an example of aspects of the transceiver 1135 described with reference to FIG. 11. The receiver 910 may utilize a single antenna or a set of antennas.

STA communications manager 915 may be an example of aspects of the STA communications manager 1115 described with reference to FIG. 11. STA communications manager 915 may also include link establishment manager 925, control field manager 930, and MAC header manager 935. Link establishment manager 925 may establish a wireless communication link between a STA and an AP, the STA including a main radio and/or a WUR.

Control field manager 930 may populate a control field with WUR operation information. In some cases, the control field manager 930 may determine to populate the control field with WUR operation information based on the data being buffered for transmission. In some cases, populating the control field refers to including in the control field an amount of time by which the STA is able to turn on the main radio from a sleep mode, a wakeup schedule of a receiver of the WUR, a wakeup interval, a wakeup duration, an indication that the receiver of the WUR is in a constant wakeup mode, a timing offset between receipt of a WUR beacon from the AP and a wakeup window of the STA, a WUR mode indicator of the STA (e.g., indicating that the STA is to enter a WUR mode), a WUR beacon start time, a WUR beacon interval, or combinations thereof.

MAC header manager 935 may transmit the control field in a MAC header of a frame over the wireless communication link. In some cases, transmitting the control field includes: transmitting the control field in the MAC header of a data frame.

Transmitter 920 may transmit signals generated by other components of the device. In some examples, the transmitter 920 may be collocated with a receiver 910 in a transceiver module. For example, the transmitter 920 may be an example of aspects of the transceiver 1135 described with reference to FIG. 11. The transmitter 920 may utilize a single antenna or a set of antennas.

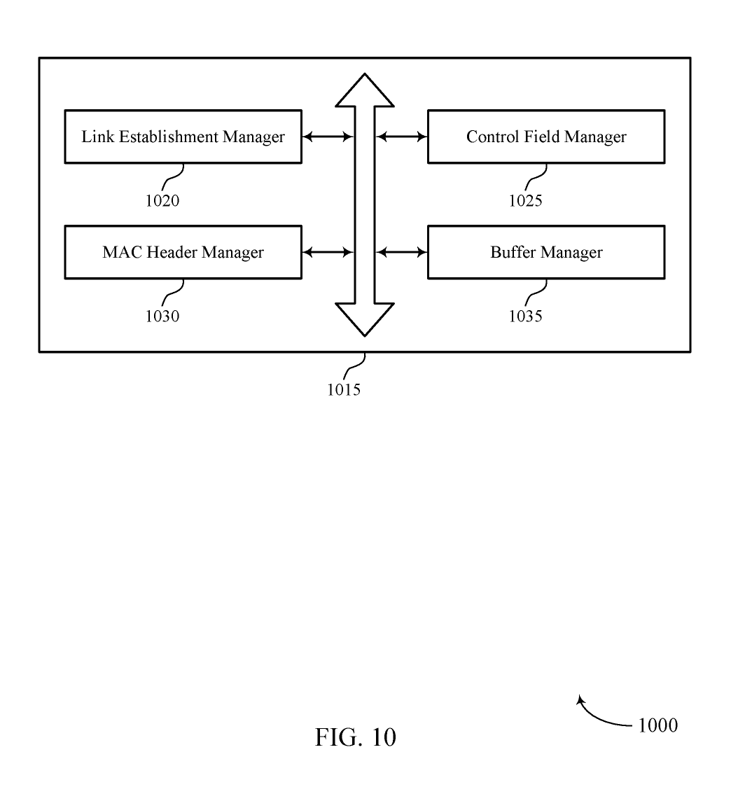

FIG. 10 shows a block diagram 1000 of a STA communications manager 1015 that supports WUR mode HE control field design and wakeup frame transmission techniques in accordance with aspects of the present disclosure. The STA communications manager 1015 may be an example of aspects of a STA communications manager 815, a STA communications manager 915, or a STA communications manager 1115 described with reference to FIGS. 8, 9, and 11. The STA communications manager 1015 may include link establishment manager 1020, control field manager 1025, MAC header manager 1030, and buffer manager 1035. Each of these modules may communicate, directly or indirectly, with one another (e.g., via one or more buses).

Link establishment manager 1020 may establish a wireless communication link between a STA and an AP, the STA including a main radio and/or a WUR.

Control field manager 1025 may populate a control field with WUR operation information. In some cases, control field manager 1025 may determine to populate the control field with WUR operation information based on the data being buffered for transmission. In some cases, populating the control field refers to including in the control field an amount of time by which the STA is able to turn on the main radio from a sleep mode, a wakeup schedule of a receiver of the WUR, a wakeup interval, a wakeup duration, an indication that the receiver of the WUR is in a constant wakeup mode, a timing offset between receipt of a WUR beacon from the AP and a wakeup window of the STA, a WUR mode indicator of the STA (e.g., indicating that the STA is to enter a WUR mode), a WUR beacon start time, a WUR beacon interval, or combinations thereof.

MAC header manager 1030 may transmit the control field in a MAC header of a frame over the wireless communication link. In some cases, transmitting the control field includes: transmitting the control field in the MAC header of a data frame. Buffer manager 1035 may identify that data is buffered for transmission.

FIG. 11 shows a diagram of a system 1100 including a device 1105 that supports WUR mode HE control field design and wakeup frame transmission techniques in accordance with aspects of the present disclosure. Device 1105 may be an example of or include the components of wireless device 805, wireless device 905, or a STA 115 as described above, e.g., with reference to FIGS. 8 and 9. Device 1105 may include components for bi-directional voice and data communications including components for transmitting and receiving communications, including STA communications manager 1115, processor 1120, memory 1125, software 1130, transceiver 1135, antenna 1140, and I/O controller 1145. These components may be in electronic communication via one or more buses (e.g., bus 1110).

Processor 1120 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting WUR mode HE control field design and wakeup frame transmission techniques).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a basic input/output system (BIOS) which may control basic hardware and/or software operation such as the interaction with peripheral components or devices.

Software 1130 may include code to implement aspects of the present disclosure, including code to support WUR mode HE control field design and wakeup frame transmission techniques. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas.

In some cases, the wireless device may include a single antenna 1140. However, in some cases the device may have more than one antenna 1140, which may be capable of concurrently transmitting or receiving multiple wireless transmissions. I/O controller 1145 may manage input and output signals for device 1105. I/O controller 1145 may also manage peripherals not integrated into device 1105. In some cases, I/O controller 1145 may represent a physical connection or port to an external peripheral. In some cases, I/O controller 1145 may utilize an operating system such as iOS®, ANDROID®, MS-DOS®, MS-WINDOWS®, OS/2®, UNIX®, LINUX®, or another known operating system. In other cases, I/O controller 1145 may represent or interact with a modem, a keyboard, a mouse, a touchscreen, or a similar device. In some cases, I/O controller 1145 may be implemented as part of a processor. In some cases, a user may interact with device 1105 via I/O controller 1145 or via hardware components controlled by I/O controller 1145.

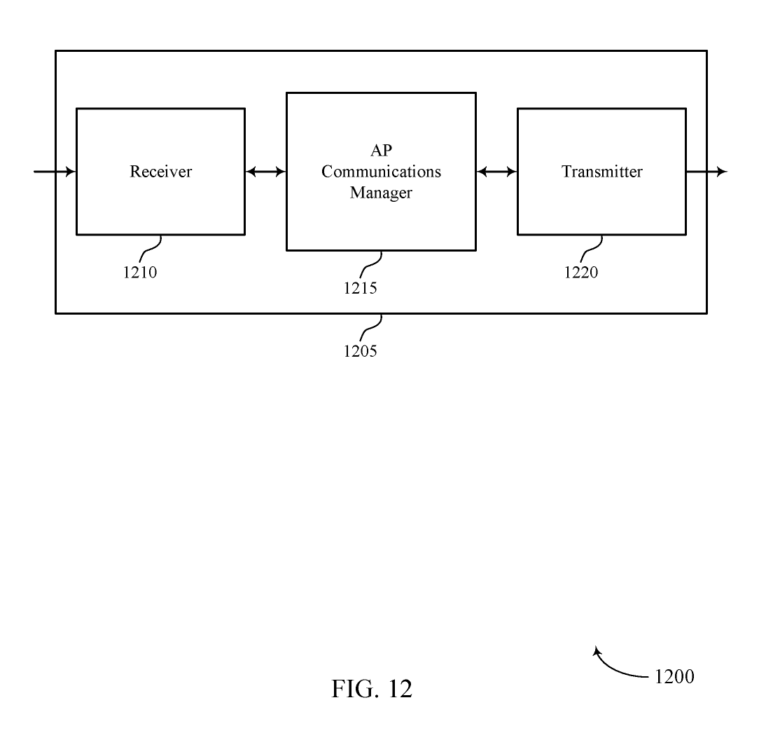

FIG. 12 shows a block diagram 1200 of a wireless device 1205 that supports WUR mode HE control field design and wakeup frame transmission techniques in accordance with aspects of the present disclosure. Wireless device 1205 may be an example of aspects of a AP 105 as described herein. Wireless device 1205 may include receiver 1210, AP communications manager 1215, and transmitter 1220. Wireless device 1205 may also include a processor. Each of these components may be in communication with one another (e.g., via one or more buses).

Receiver 1210 may receive information such as packets, user data, or control information associated with various information channels (e.g., control channels, data channels, and information related to WUR mode HE control field design and wakeup frame transmission techniques, etc.). Information may be passed on to other components of the device. The receiver 1210 may be an example of aspects of the transceiver 1135 described with reference to FIG. 11. The receiver 1210 may utilize a single antenna or a set of antennas.

AP communications manager 1215 may be an example of aspects of the AP communications manager 1115 described with reference to FIG. 11. AP communications manager 1215 and/or at least some of its various sub-components may be implemented in hardware, software executed by a processor, firmware, or any combination thereof. If implemented in software executed by a processor, the functions of the AP communications manager 1215 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The AP communications manager 1215 and/or at least some of its various sub-components may be physically located at various positions, including being distributed such that portions of functions are implemented at different physical locations by one or more physical devices. In some examples, AP communications manager 1215 and/or at least some of its various sub-components may be a separate and distinct component in accordance with various aspects of the present disclosure. In other examples, AP communications manager 1215 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

AP communications manager 1215 may establish a wireless communication link between a STA (e.g., including a main radio and/or a WUR) and an AP, populate a control field with WUR operation information, and transmit the control field in a MAC header of a frame over the wireless communication link. The AP communications manager 1215 may also establish a wireless communication link with a STA that includes a main radio and/or a WUR and await an acknowledgement timeout interval for reception of an acknowledgement of the wakeup packet from the STA. The acknowledgement timeout interval may be a function of pending traffic between the AP and the STA. The AP communications manager 1215 may also establish a wireless communication link with a STA that includes a main radio and/or a WUR and determine a number of wakeup packets to transmit to the STA. The number of wakeup packets to transmit may be determined as a function of pending traffic between the AP and the STA. AP communications manager 1215 may then transmit the wakeup packets to the STA until an acknowledgement is received from the STA or the determined number of wakeup packets is transmitted.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1135 described with reference to FIG. 11. The transmitter 1220 may utilize a single antenna or a set of antennas. As described herein, transmitter 1220 may transmit a wakeup packet to the STA.

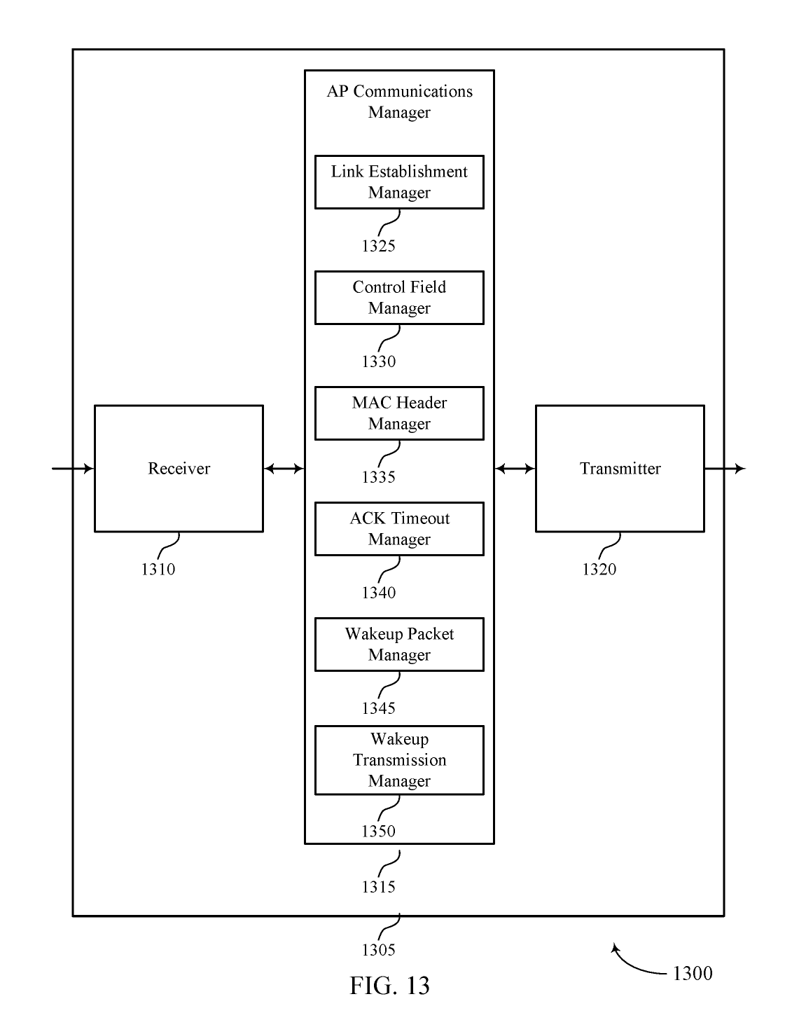

FIG. 13 shows a block diagram 1300 of a wireless device 1305 that supports WUR mode HE control field design and wakeup frame transmission techniques in accordance with aspects of the present disclosure. Wireless device 1305 may be an example of aspects of a wireless device 1205 or a AP 105 as described with reference to FIG. 12. Wireless device 1305 may include receiver 1310, AP communications manager 1315, and transmitter 1320. Wireless device 1305 may also include a processor. Each of these components may be in communication with one another (e.g., via one or more buses).

Receiver 1310 may receive information such as packets, user data, or control information associated with various information channels (e.g., control channels, data channels, and information related to WUR mode HE control field design and wakeup frame transmission techniques, etc.). Information may be passed on to other components of the device. The receiver 1310 may be an example of aspects of the transceiver 1135 described with reference to FIG. 11. The receiver 1310 may utilize a single antenna or a set of antennas.

AP communications manager 1315 may be an example of aspects of the AP communications manager 1115 described with reference to FIG. 11. AP communications manager 1315 may also include link establishment manager 1325, control field manager 1330, MAC header manager 1335, acknowledgement (ACK) timeout manager 1340, wakeup packet manager 1345, and wakeup transmission manager 1350.

Link establishment manager 1325 may establish a wireless communication link between a STA and an AP, the STA including a main radio and/or a WUR and establish a wireless communication link with a STA that includes a main radio and/or a WUR.

Control field manager 1330 may populate a control field with WUR operation information. For example, control field manager 1330 may determine to populate the control field with WUR operation information based on the data being buffered for transmission. In some cases, populating the control field refers to including in the control field a transmission schedule of a WUR beacon of the AP, a WUR operation frequency band, a WUR modulation and control scheme (MCS), a STA identification to be included in a wakeup packet for the STA, a wakeup packet acknowledgment timeout interval (e.g., indicating an amount of time that the AP will wait to receive a packet from the STA after transmission of a wakeup packet), or combinations thereof.

MAC header manager 1335 may transmit the control field in a MAC header of a frame over the wireless communication link. In some cases, transmitting the control field includes transmitting the control field in the MAC header of a data frame.

ACK timeout manager 1340 may await an acknowledgement timeout interval for reception of an acknowledgement of the wakeup packet from the STA. For example, the acknowledgement timeout interval may be a function of pending traffic between the AP and the STA. Further ACK timeout manager 1340 may reduce the acknowledgement timeout interval as a priority of the pending traffic increases and determine respective acknowledgement timeout intervals for each of multiple concurrent traffic flows.

Wakeup packet manager 1345 may determine a number of wakeup packets to transmit to the STA. For example, the number of wakeup packets may be a function of pending traffic between the AP and the STA. In some cases, wakeup packet manager 1345 may increase the number of wakeup packets as a priority of the pending traffic increases and adjust the number of wakeup packets based on a QoS requirement. The QoS requirement may be at least a portion of the function of pending traffic. In some cases, the QoS requirement is based on whether the pending traffic between the AP and the STA corresponds to real-time or non-real-time application. In some cases, the QoS requirement is based on an access category or a user priority of pending traffic between the AP and the STA. Additionally or alternatively, the QoS requirement is based on one or more QoS parameters of pending traffic between the AP and the STA. Additionally or alternatively, the one or more QoS parameters include a range of delay bound specified in a traffic specification element per QoS traffic flow.

Wakeup transmission manager 1350 may transmit the wakeup packets to the STA until an acknowledgement is received from the STA or the determined number of wakeup packets is transmitted.

Transmitter 1320 may transmit signals generated by other components of the device. In some examples, the transmitter 1320 may be collocated with a receiver 1310 in a transceiver module. For example, the transmitter 1320 may be an example of aspects of the transceiver 1135 described with reference to FIG. 11. The transmitter 1320 may utilize a single antenna or a set of antennas.

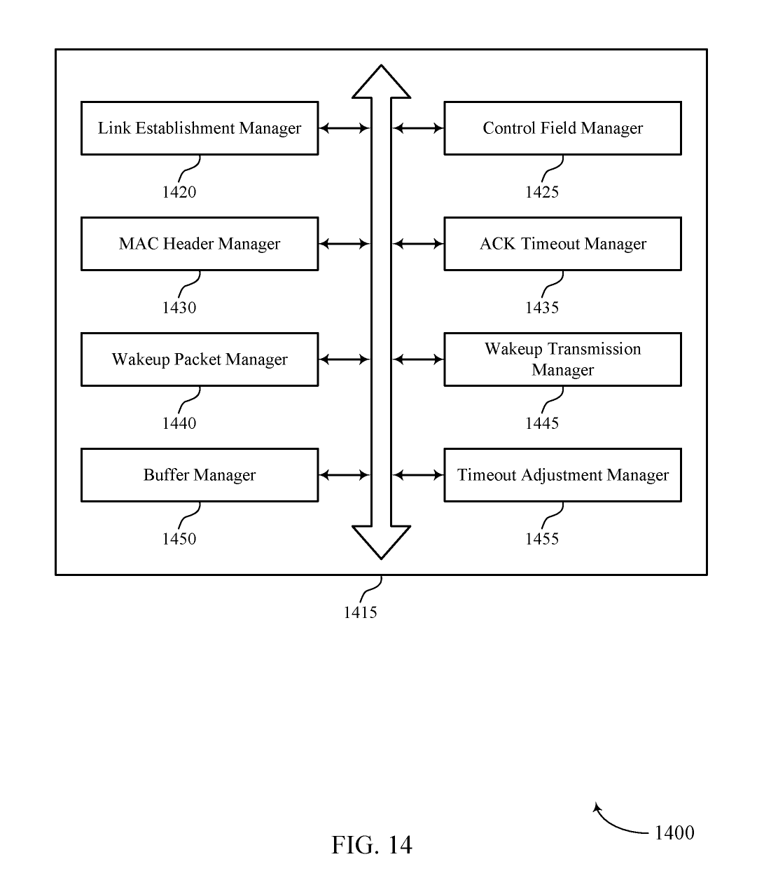

FIG. 14 shows a block diagram 1400 of a AP communications manager 1415 that supports WUR mode HE control field design and wakeup frame transmission techniques in accordance with aspects of the present disclosure. The AP communications manager 1415 may be an example of aspects of a AP communications manager 1215, a AP communications manager 1315, or a AP communications manager 1115 described with reference to FIGS. 12, 13, and 11. The AP communications manager 1415 may include link establishment manager 1420, control field manager 1425, MAC header manager 1430, ACK timeout manager 1435, wakeup packet manager 1440, wakeup transmission manager 1445, buffer manager 1450, and timeout adjustment manager 1455. Each of these modules may communicate, directly or indirectly, with one another (e.g., via one or more buses).

Link establishment manager 1420 may establish a wireless communication link between a STA and an AP, the STA including a main radio and/or a WUR and establish a wireless communication link with a STA that includes a main radio and/or a WUR.

Control field manager 1425 may populate a control field with WUR operation information. For example, control field manager 1425 may determine to populate the control field with WUR operation information based on the data being buffered for transmission. In some cases, populating the control field refers to including in the control field a transmission schedule of a WUR beacon of the AP, a WUR operation frequency band, a WUR MCS, a STA identification to be included in a wakeup packet for the STA, a wakeup packet acknowledgment timeout interval (e.g., indicating an amount of time that the AP will wait to receive a packet from the STA after transmission of a wakeup packet), or combinations thereof.

MAC header manager 1430 may transmit the control field in a MAC header of a frame over the wireless communication link. In some cases, transmitting the control field includes: transmitting the control field in the MAC header of a data frame.

ACK timeout manager 1435 may await an acknowledgement timeout interval for reception of an acknowledgement of the wakeup packet from the STA. For example, the acknowledgement timeout interval may be a function of pending traffic between the AP and the STA. ACK timeout manager 1435 may further reduce the acknowledgement timeout interval as a priority of the pending traffic increases and determine respective acknowledgement timeout intervals for each of multiple concurrent traffic flows.

Wakeup packet manager 1440 may determine a number of wakeup packets to transmit to the STA. For example, the number of wakeup packets transmitted may be a function of pending traffic between the AP and the STA. Further, wakeup packet manager 1440 may increase the number of wakeup packets as a priority of the pending traffic increases and adjust the number of wakeup packets based on a QoS requirement. The QoS requirement is at least a portion of the function of pending traffic. In some cases, the QoS requirement is based on whether the pending traffic between the AP and the STA corresponds to real-time or non-real-time application. Additionally or alternatively, the QoS requirement is based on an access category or a user priority of pending traffic between the AP and the STA. Additionally or alternatively, the QoS requirement is based on one or more QoS parameters of pending traffic between the AP and the STA. Additionally or alternatively, the one or more QoS parameters include a range of delay bound specified in a traffic specification element per QoS traffic flow.

Wakeup transmission manager 1445 may transmit the wakeup packets to the STA until an acknowledgement is received from the STA or the determined number of wakeup packets is transmitted. Buffer manager 1450 may identify that data is buffered for transmission.

Timeout adjustment manager 1455 may adjust the acknowledgement timeout interval based on a QoS requirement, where the QoS requirement is at least a portion of the function of pending traffic. Timeout adjustment manager 1455 may further adjust the acknowledgement timeout interval based on a shortest of the respective acknowledgement timeout intervals. In some cases, the QoS requirement is based on whether the pending traffic between the AP and the STA corresponds to real-time or non-real-time application. In some cases, the QoS requirement is based on an access category or a user priority of pending traffic between the AP and the STA. In some cases, the QoS requirement is based on one or more QoS parameters of pending traffic between the AP and the STA. In some cases, the one or more QoS parameters include a range of delay bound specified in a traffic specification element per QoS traffic flow.

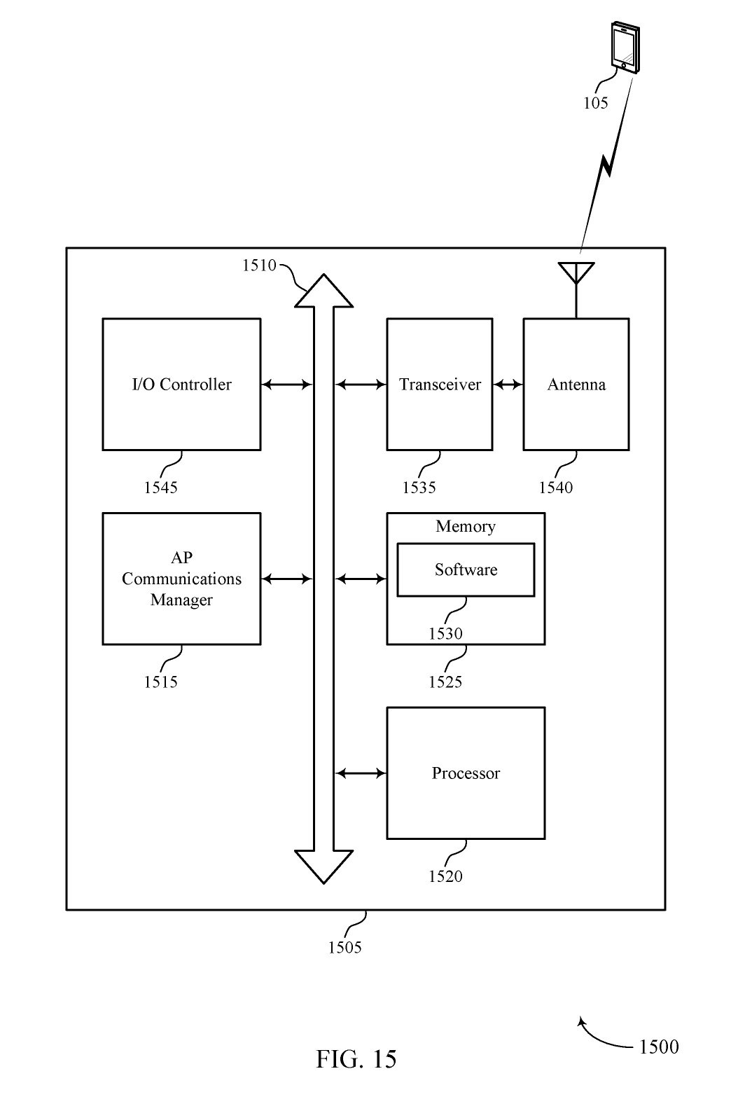

FIG. 15 shows a diagram of a system 1500 including a device 1505 that supports WUR mode HE control field design and wakeup frame transmission techniques in accordance with aspects of the present disclosure. Device 1505 may be an example of or include the components of wireless device 1205, wireless device 1305, or a AP 105 as described above, e.g., with reference to FIGS. 12 and 13. Device 1505 may include components for bi-directional voice and data communications including components for transmitting and receiving communications, including AP communications manager 1515, processor 1520, memory 1525, software 1530, transceiver 1535, antenna 1540, and I/O controller 1545. These components may be in electronic communication via one or more buses (e.g., bus 1510).

Processor 1520 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1520 may be configured to operate a memory array using a memory controller. In other cases, a memory controller may be integrated into processor 1520. Processor 1520 may be configured to execute computer-readable instructions stored in a memory to perform various functions (e.g., functions or tasks supporting WUR mode HE control field design and wakeup frame transmission techniques).

Memory 1525 may include random access memory (RAM) and read only memory (ROM). The memory 1525 may store computer-readable, computer-executable software 1530 including instructions that, when executed, cause the processor to perform various functions described herein. In some cases, the memory 1525 may contain, among other things, a basic input/output system (BIOS) which may control basic hardware and/or software operation such as the interaction with peripheral components or devices.

Software 1530 may include code to implement aspects of the present disclosure, including code to support WUR mode HE control field design and wakeup frame transmission techniques. Software 1530 may be stored in a non-transitory computer-readable medium such as system memory or other memory. In some cases, the software 1530 may not be directly executable by the processor but may cause a computer (e.g., when compiled and executed) to perform functions described herein.

Transceiver 1535 may communicate bi-directionally, via one or more antennas, wired, or wireless links as described above. For example, the transceiver 1535 may represent a wireless transceiver and may communicate bi-directionally with another wireless transceiver. The transceiver 1535 may also include a modem to modulate the packets and provide the modulated packets to the antennas for transmission, and to demodulate packets received from the antennas.

In some cases, the wireless device may include a single antenna 1540. However, in some cases the device may have more than one antenna 1540, which may be capable of concurrently transmitting or receiving multiple wireless transmissions.

I/O controller 1545 may manage input and output signals for device 1505. I/O controller 1545 may also manage peripherals not integrated into device 1505. In some cases, I/O controller 1545 may represent a physical connection or port to an external peripheral. In some cases, I/O controller 1545 may utilize an operating system such as iOS®, ANDROID®, MS-DOS®, MS-WINDOWS®, OS/2®, UNIX®, LINUX®, or another known operating system. In other cases, I/O controller 1545 may represent or interact with a modem, a keyboard, a mouse, a touchscreen, or a similar device. In some cases, I/O controller 1545 may be implemented as part of a processor. In some cases, a user may interact with device 1505 via I/O controller 1545 or via hardware components controlled by I/O controller 1545.

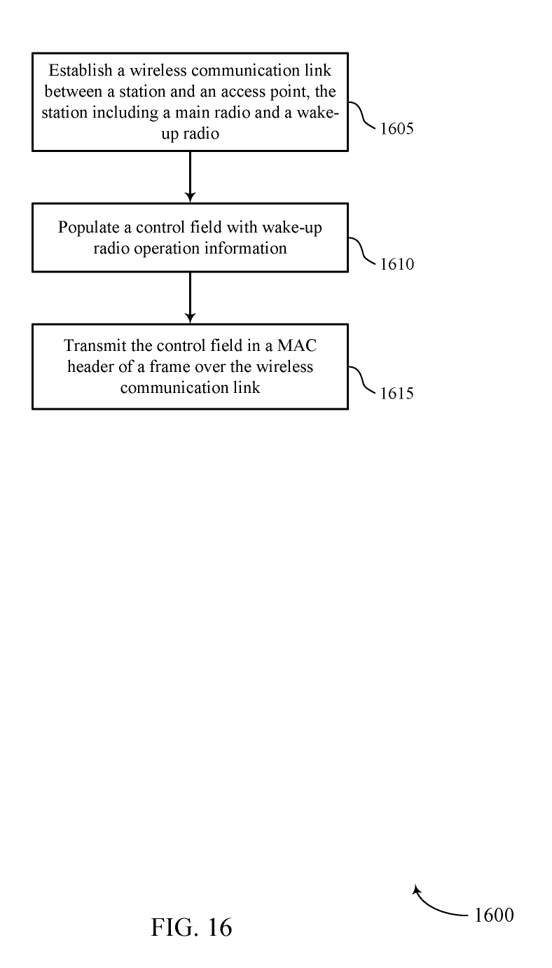

FIG. 16 shows a flowchart illustrating a method 1600 for WUR mode HE control field design and wakeup frame transmission techniques in accordance with aspects of the present disclosure. The operations of method 1600 may be implemented by a AP 105 or its components as described herein. For example, the operations of method 1600 may be performed by a AP communications manager as described with reference to FIGS. 12 through 15. In some examples, a AP 105 may execute a set of codes to control the functional elements of the device to perform the functions described below. Additionally or alternatively, the AP 105 may perform aspects of the functions described below using special-purpose hardware.

At block 1605 the AP 105 may establish a wireless communication link between a STA and an AP, the STA including a main radio and/or a WUR. The operations of block 1605 may be performed according to the methods described herein. In certain examples, aspects of the operations of block 1605 may be performed by a link establishment manager as described with reference to FIGS. 12 through 15.

At block 1610 the AP 105 may populate a control field with WUR operation information. The operations of block 1610 may be performed according to the methods described herein. In certain examples, aspects of the operations of block 1610 may be performed by a control field manager as described with reference to FIGS. 12 through 15.

At block 1615 the AP 105 may transmit the control field in a MAC header of a frame over the wireless communication link. The operations of block 1615 may be performed according to the methods described herein. In certain examples, aspects of the operations of block 1615 may be performed by a MAC header manager as described with reference to FIGS. 12 through 15.

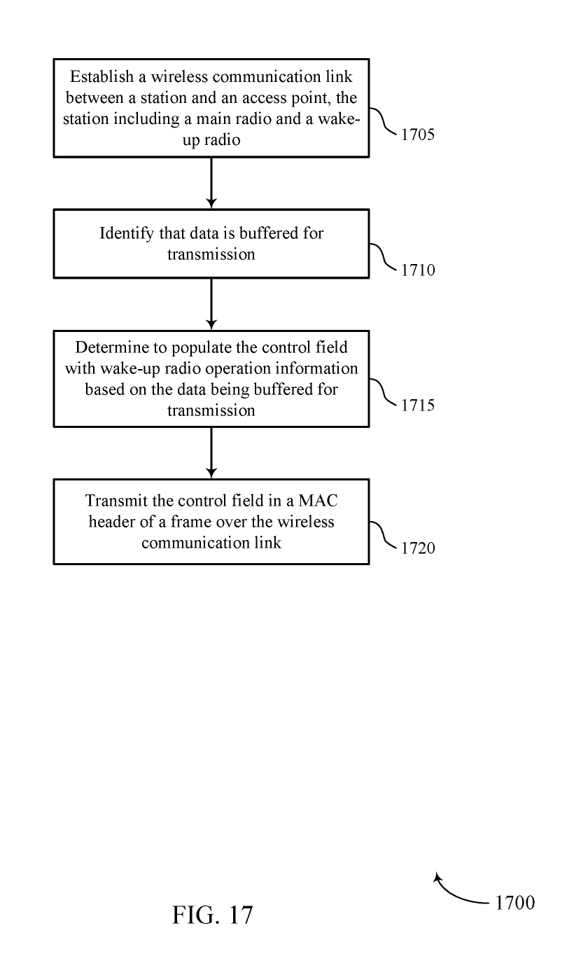

FIG. 17 shows a flowchart illustrating a method 1700 for WUR mode HE control field design and wakeup frame transmission techniques in accordance with aspects of the present disclosure. The operations of method 1700 may be implemented by a AP 105 or its components as described herein. For example, the operations of method 1700 may be performed by a AP communications manager as described with reference to FIGS. 12 through 15. In some examples, a AP 105 may execute a set of codes to control the functional elements of the device to perform the functions described below. Additionally or alternatively, the AP 105 may perform aspects of the functions described below using special-purpose hardware.

At block 1705 the AP 105 may establish a wireless communication link between a STA and an AP, the STA including a main radio and/or a WUR. The operations of block 1705 may be performed according to the methods described herein. In certain examples, aspects of the operations of block 1705 may be performed by a link establishment manager as described with reference to FIGS. 12 through 15.

At block 1710 the AP 105 may identify that data is buffered for transmission. The operations of block 1710 may be performed according to the methods described herein. In certain examples, aspects of the operations of block 1710 may be performed by a buffer manager as described with reference to FIGS. 12 through 15.

At block 1715 the AP 105 may determine to populate the control field with WUR operation information based on the data being buffered for transmission. The operations of block 1715 may be performed according to the methods described herein. In certain examples, aspects of the operations of block 1715 may be performed by a control field manager as described with reference to FIGS. 12 through 15.

At block 1720 the AP 105 may transmit the control field in a MAC header of a frame over the wireless communication link. The operations of block 1720 may be performed according to the methods described herein. In certain examples, aspects of the operations of block 1720 may be performed by a MAC header manager as described with reference to FIGS. 12 through 15.

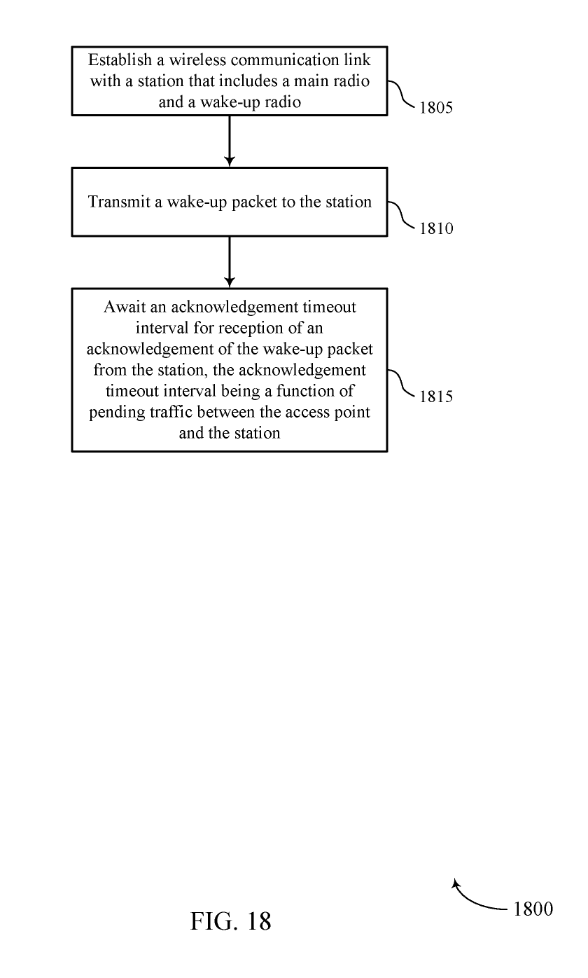

FIG. 18 shows a flowchart illustrating a method 1800 for WUR mode HE control field design and wakeup frame transmission techniques in accordance with aspects of the present disclosure. The operations of method 1800 may be implemented by a AP 105 or its components as described herein. For example, the operations of method 1800 may be performed by a AP communications manager as described with reference to FIGS. 12 through 15. In some examples, a AP 105 may execute a set of codes to control the functional elements of the device to perform the functions described below. Additionally or alternatively, the AP 105 may perform aspects of the functions described below using special-purpose hardware.

At block 1805 the AP 105 may establish a wireless communication link with a STA that includes a main radio and/or a WUR. The operations of block 1805 may be performed according to the methods described herein. In certain examples, aspects of the operations of block 1805 may be performed by a link establishment manager as described with reference to FIGS. 12 through 15.

At block 1810 the AP 105 may transmit a wakeup packet to the STA. The operations of block 1810 may be performed according to the methods described herein. In certain examples, aspects of the operations of block 1810 may be performed by a transmitter as described with reference to FIGS. 12 through 15.

At block 1815 the AP 105 may await an acknowledgement timeout interval for reception of an acknowledgement of the wakeup packet from the STA, the acknowledgement timeout interval being a function of pending traffic between the AP and the STA. The operations of block 1815 may be performed according to the methods described herein. In certain examples, aspects of the operations of block 1815 may be performed by a ACK timeout manager as described with reference to FIGS. 12 through 15.

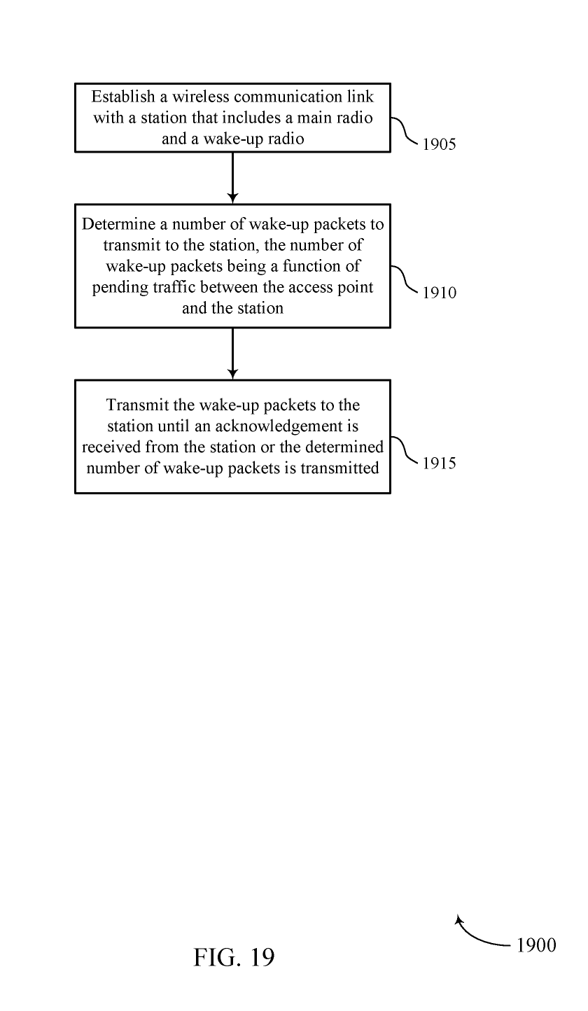

FIG. 19 shows a flowchart illustrating a method 1900 for WUR mode HE control field design and wakeup frame transmission techniques in accordance with aspects of the present disclosure. The operations of method 1900 may be implemented by a AP 105 or its components as described herein. For example, the operations of method 1900 may be performed by a AP communications manager as described with reference to FIGS. 12 through 15. In some examples, a AP 105 may execute a set of codes to control the functional elements of the device to perform the functions described below. Additionally or alternatively, the AP 105 may perform aspects of the functions described below using special-purpose hardware.

At block 1905 the AP 105 may establish a wireless communication link with a STA that includes a main radio and/or a WUR. The operations of block 1905 may be performed according to the methods described herein. In certain examples, aspects of the operations of block 1905 may be performed by a link establishment manager as described with reference to FIGS. 12 through 15.

At block 1910 the AP 105 may determine a number of wakeup packets to transmit to the STA, the number of wakeup packets being a function of pending traffic between the AP and the STA. The operations of block 1910 may be performed according to the methods described herein. In certain examples, aspects of the operations of block 1910 may be performed by a wakeup packet manager as described with reference to FIGS. 12 through 15.

At block 1915 the AP 105 may transmit the wakeup packets to the STA until an acknowledgement is received from the STA or the determined number of wakeup packets is transmitted. The operations of block 1915 may be performed according to the methods described herein. In certain examples, aspects of the operations of block 1915 may be performed by a wakeup transmission manager as described with reference to FIGS. 12 through 15.

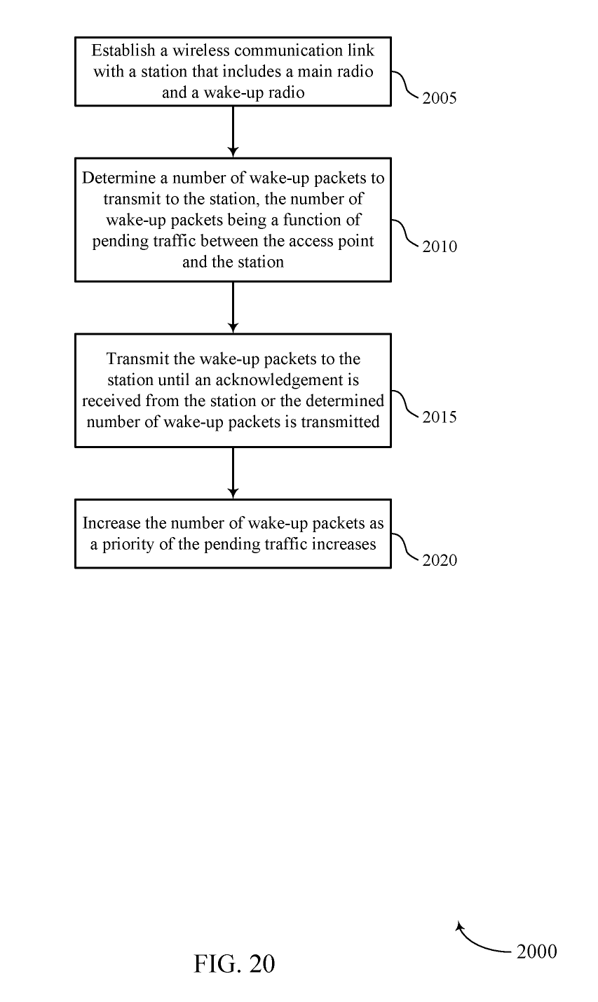

FIG. 20 shows a flowchart illustrating a method 2000 for WUR mode HE control field design and wakeup frame transmission techniques in accordance with aspects of the present disclosure. The operations of method 2000 may be implemented by a AP 105 or its components as described herein. For example, the operations of method 2000 may be performed by a AP communications manager as described with reference to FIGS. 12 through 15. In some examples, a AP 105 may execute a set of codes to control the functional elements of the device to perform the functions described below. Additionally or alternatively, the AP 105 may perform aspects of the functions described below using special-purpose hardware.

At block 2005 the AP 105 may establish a wireless communication link with a STA that includes a main radio and/or a WUR. The operations of block 2005 may be performed according to the methods described herein. In certain examples, aspects of the operations of block 2005 may be performed by a link establishment manager as described with reference to FIGS. 12 through 15.

At block 2010 the AP 105 may determine a number of wakeup packets to transmit to the STA, the number of wakeup packets being a function of pending traffic between the AP and the STA. The operations of block 2010 may be performed according to the methods described herein. In certain examples, aspects of the operations of block 2010 may be performed by a wakeup packet manager as described with reference to FIGS. 12 through 15.

At block 2015 the AP 105 may transmit the wakeup packets to the STA until an acknowledgement is received from the STA or the determined number of wakeup packets is transmitted. The operations of block 2015 may be performed according to the methods described herein. In certain examples, aspects of the operations of block 2015 may be performed by a wakeup transmission manager as described with reference to FIGS. 12 through 15.

At block 2020 the AP 105 may increase the number of wakeup packets as a priority of the pending traffic increases. The operations of block 2020 may be performed according to the methods described herein. In certain examples, aspects of the operations of block 2020 may be performed by a wakeup packet manager as described with reference to FIGS. 12 through 15.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the STAs may have similar frame timing, and transmissions from different STAs may be approximately aligned in time. For asynchronous operation, the STAs may have different frame timing, and transmissions from different STAs may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and WLAN 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
establishing a wireless communication link between a station and an access point, the station including a main radio and a wakeup radio;
populating a control field with wakeup radio operation information; and
transmitting the control field in a media access control (MAC) header of a frame over the wireless communication link.

2. The method of claim 1, wherein transmitting the control field comprises:
transmitting the control field in the MAC header of a data frame.

3. The method of claim 1, further comprising:
identifying that data is buffered for transmission; and
determining to populate the control field with wakeup radio operation information based on the data being buffered for transmission.

4. The method of claim 1, wherein populating the control field comprises:
including, in the control field, a wakeup schedule of a receiver of the wakeup radio.

5. The method of claim 4, wherein including the wakeup schedule in the control field comprises:
including, in the control field, a wakeup interval, a wakeup duration, an indication that the receiver of the wakeup radio is in a constant wakeup mode, or combinations thereof.

6. The method of claim 4, wherein including the wakeup schedule in the control field comprises:
including, in the control field, a timing offset between receipt of a wakeup radio beacon from the access point and a wakeup window of the station.

7. The method of claim 1, wherein populating the control field comprises:
including, in the control field, a transmission schedule of a wakeup radio beacon of the access point.

8. The method of claim 7, wherein including the transmission schedule in the control field comprises:
including, in the control field, a wakeup radio beacon start time, a wakeup radio beacon interval, or combinations thereof.

9. The method of claim 1, wherein populating the control field comprises:
including, in the control field, a wakeup radio operation frequency band, a wakeup radio modulation and coding scheme (MCS), or combinations thereof.

10. The method of claim 1, wherein populating the control field comprises:
including, in the control field, a wakeup radio mode indicator of the station indicating that the station is to enter a wakeup radio mode.

11. The method of claim 1, wherein populating the control field comprises:
including, in the control field, a station identification to be included in a wakeup packet for the station.

12. The method of claim 1, wherein populating the control field comprises:
including, in the control field, a wakeup packet acknowledgment timeout interval indicating an amount of time that the access point will wait to receive a packet from the station after transmission of a wakeup packet.

13. The method of claim 1, wherein populating the control field comprises:
including, in the control field, an amount of time by which the station is able to turn on the main radio from a sleep mode.

14. A method for wireless communication at an access point, comprising:
establishing a wireless communication link with a station that includes a main radio and a wakeup radio;
transmitting a wakeup packet to the station; and
awaiting an acknowledgement timeout interval for reception of an acknowledgement of the wakeup packet from the station, the acknowledgement timeout interval being a function of pending traffic between the access point and the station.

15. The method of claim 14, further comprising:
reducing the acknowledgement timeout interval as a priority of the pending traffic increases.

16. The method of claim 14, further comprising:
adjusting the acknowledgement timeout interval based at least in part on a quality of service requirement, wherein the quality of service requirement is at least a portion of the function of pending traffic.

17. The method of claim 16, wherein:
the quality of service requirement is based at least in part on whether the pending traffic between the access point and the station corresponds to real-time or non-real-time application.

18. The method of claim 16, wherein:
the quality of service requirement is based at least in part on an access category or a user priority of pending traffic between the access point and the station.

19. The method of claim 16, wherein:
the quality of service requirement is based at least in part on one or more quality of service parameters of pending traffic between the access point and the station.

20. The method of claim 19, wherein:
the one or more quality of service parameters include a range of delay bound specified in a traffic specification element per quality of service traffic flow.

21. The method of claim 14, further comprising:
determining respective acknowledgement timeout intervals for each of multiple concurrent traffic flows; and
adjusting the acknowledgement timeout interval based on a shortest of the respective acknowledgement timeout intervals.

22. A method for wireless communication at an access point, comprising:
establishing a wireless communication link with a station that includes a main radio and a wakeup radio;
determining a number of wakeup packets to transmit to the station, the number of wakeup packets being a function of pending traffic between the access point and the station; and
transmitting the wakeup packets to the station until an acknowledgement is received from the station or the determined number of wakeup packets is transmitted.

23. The method of claim 22, further comprising:
increasing the number of wakeup packets as a priority of the pending traffic increases.

24. The method of claim 22, further comprising:
adjusting the number of wakeup packets based at least in part on a quality of service requirement, wherein the quality of service requirement is at least a portion of the function of pending traffic.

25. The method of claim 24, wherein:
the quality of service requirement is based at least in part on whether the pending traffic between the access point and the station corresponds to real-time or non-real-time application.

26. The method of claim 24, wherein:
the quality of service requirement is based at least in part on an access category or a user priority of pending traffic between the access point and the station.

27. The method of claim 24, wherein:
the quality of service requirement is based at least in part on one or more quality of service parameters of pending traffic between the access point and the station.

28. The method of claim 27, wherein:
the one or more quality of service parameters include a range of delay bound specified in a traffic specification element per quality of service traffic flow.

29. An apparatus for wireless communication, comprising:
a processor;
memory in electronic communication with the processor; and
instructions stored in the memory and operable, when executed by the processor, to cause the apparatus to:
establish a wireless communication link between a station and an access point, the station including a main radio and a wakeup radio;
populate a control field with wakeup radio operation information; and
transmit the control field in a media access control (MAC) header of a frame over the wireless communication link.

30. The apparatus of claim 29, wherein the instructions are further executable by the processor to:
identify that data is buffered for transmission; and
determine to populate the control field with wakeup radio operation information based on the data being buffered for transmission.
